(19) United States
(12) Patent Application Publication
(10) Pub. No.: US 2020/0005413 A1
(43) Pub. Date: Jan. 2, 2020

(54) Interactive and Real-Time Absentee Reporting and Flagging System for Schools, Parents and Other Institutions

(71) Applicants: Sandra Wilkinson, Powell, OH (US); Sherrie Wilkinson, Powell, OH (US)

(72) Inventors: Sandra Wilkinson, Powell, OH (US); Sherrie Wilkinson, Powell, OH (US)

(21) Appl. No.: 16/537,974

(22) Filed: Aug. 12, 2019

Related U.S. Application Data
(63) Continuation-in-part of application No. 14/835,484, filed on Aug. 25, 2015, now abandoned.

(51) Int. Cl. G06Q 50/20; G08B 21/22; G08B 5/22

(52) U.S. Cl. CPC G06Q 50/205; G08B 5/229; G08B 21/22

(57) ABSTRACT

A method and system are disclosed for interactive participation by parents with educational/school facilities and other governmental institutions wherein all are kept aware of the current location and the current absentee and other documented conditions (grades/tardiness/absentee record etc.) of a specific student. By having attendance data, one can see negative tendencies or significant shifts in a student's attendance. This can further benefit counselors, teachers, parents and guardians to expand their watch for behavior shifts of individual students through interviews, surveying media such as Facebook™, chat lines, Twitter™, Snap Chat™ and text messages (i.e. red flags indicating a change in one's environment and potential need for counseling or behavior analysis).

### CROSS-REFERENCE TO RELATED APPLICATIONS

This application is a Continuation-in-Part [C.I.P.] filed under 37 CFR 1.53(b) and claims the benefit of the original, non-provisional (Regular Utility) U.S. Patent Application Ser. No. 14/835,484 submitted Aug. 25, 2015 and published as US 2016/0062977 A1 on Mar. 3, 2016. The original application was still active on the date of the submission of this C.I.P. The original is entitled an “Interactive and Real-Time Absentee Reporting System for Schools, Parents and Other Institutions” and was submitted by Sandra Wilkinson and Sherrie Wilkinson, inventors. The original application is incorporated fully by reference as if it were reproduced here, verbatim. The original application claimed the benefit of U.S. Provisional Patent Application with Ser. No. 62/041,382 filed Aug. 28, 2014 by Sandra Wilkinson and Sherrie Wilkinson and also entitled “Interactive and Real-Time Absentee Reporting System for Schools, Parents and Other Institutions”.

### FIELD OF INVENTION

This invention relates to an Interactive and Real-Time Absentee Reporting and Flagging System for Schools, Parents and Other Institutions. More particularly, this invention relates to systems and methods for tracking the location of individuals, such as students entering or leaving a classroom/school and for managing critical student information. The present invention also relates to methods of reporting student behavior, and in particular a method of reporting student relevant data including behavior (and grades) to parents and interested institutions over a computer network. This invention relates to an attendance monitoring system. More particularly, the invention is directed to a system that provides to a school system, parents or interested institutions an instant visual representation of a student's daily attendance (including that for the present day) and attendance history (which is an indicator of potential concerns). The present embodiments further relate to an immediate response information or emergency system for guardians, employees, and students associated with an institution, such as a school or a school system relating to student daily attendance which can relate to tracking attendance of a child in case of an emergency situation or knowing where the child is while in an institution or school system. This invention relates to data logging systems, and in particular, to systems for logging or registering items of data related to persons. It is, although not exclusively, adapted for use as a classroom roll-taking system, for recording the presence or absence of pupils or students, their test results and other such data. This relates further to a significant improvement to an attendance system that can show behavior shifts that may need or should merit further investigation. By having attendance data at one's fingertips, one can see negative tendencies or significant shifts in a student's attendance. This can benefit counselors, teachers, parents and guardians to expand their “watch for behavior shifts” of individual students. A shift can merit other investigations through interviews, surveying media [such as Facebook™, chat lines, Twitter™, Snap Chat™, and text messages (i.e. red flags indicating a change in one's reaction to their personal environment and potential need for counseling or behavior analysis). This significant improvement in attendance data can also be used by principals or superintendents to correlate attendance shifts with gang behavior, bullying, or other matters which can be addressed with planning future changes for the schools or even getting grants to combat negative shifts in the schools. All from absentee data.

### FEDERALLY SPONSORED RESEARCH

None.

### SEQUENCE LISTING OR PROGRAM

None.

### BACKGROUND-FIELD OF INVENTION AND PRIOR ART

As far as known, there are no Interactive and Real-Time Absentee Reporting and Flagging System for Schools, Parents and Other Institutions or the like. It is believed that this process/system is unique in its manner and technologies.

### GENERAL BACKGROUND

For many educational and other institutions, tracking attendance can be a time-consuming and tedious chore. Most educational facilities and systems perform the task of collecting and maintaining student information by using time worn manual accounting techniques. Typically, a teacher takes attendance manually, by asking each student to state “here” when his or her name is called, or by scanning the classroom to determine which students are present. The teacher then writes the information down, and it is transmitted to the school administration, often by hand (or a computerized system). The teacher's entries are then manually transferred to a more permanent record for storage and/or subsequent forwarding to a school district office. The mere fact that the entire accounting process is manually performed by a number of different people presents the strong likelihood that errors are created, accumulated, and then compounded.

The time spent taking attendance is typically multiplied and further amplified by the fact that students tend to rotate from classroom to classroom as they change subjects; as a result, attendance must be taken each class. Some form of centralized attendance information processing must therefore be employed in which data from each classroom and teacher is combined to result in an attendance profile with respect to each individual student. Typically, if this task is performed, it is done on paper in a very slow and clerical manner. (Many schools have started using some form of software attendance). Importantly, if a student enters the class late, after attendance has been taken, the teacher must take note of that fact, and interrupt teaching to update his or her attendance records. This traditional method of tracking attendance suffers from a number of drawbacks. The process is tedious, time-consuming, and subject to human error. Like all paper-based recordkeeping systems, the system is vulnerable to lost or misfiled data. The consequences of poor attendance recordkeeping can be significant for schools, administrators, and school districts. Throughout the country, average daily attendance (ADA) is a critical statistic that is used to determine school funding. Since school funding is based on ADA figures, schools lose money every time a student is absent. And when poor or inconsistent attendance tracking wrongly indicates that a present student is absent, the school needlessly loses funding.

Student information is useful to present-day educational facilities for a number of reasons other than simply satisfying the requirement for monitoring students' progress. For example, student body attendance is often the factor on which state and/or federal financial assistance is based. Recognizing that errors are common, governmental agencies have instituted auditing procedures to ensure accuracy. An automated system would not only ensure accuracy but would also eliminate the need for such audit procedures and hence produce a governmental savings. As a further example, school administrators are frequently faced with having to solve problems attendant to student unrest and campus disturbances. It has been found that such disturbances sometimes can be predicted, and possibly pre-empted and avoided, by monitoring the attendance records and campus whereabouts, i.e., is a student in the proper classroom, of known and/or suspected instigators. Obviously, manual accounting techniques can be and are totally unsuitable for this purpose when such checking must be performed on a class period basis or at other similarly short and regular time intervals through a day. An automated system (possibly/probably already in place) would make student information continually available at a minute's notice. In addition, traditional attendance tracking methods make it difficult to prepare the attendance reports required by governmental agencies. Various agencies require ADA and other data to be reported in particular formats, but the traditional methods of tracking attendance do not provide an easy way to prepare these reports.

The education system is currently struggling to provide a uniformly high quality of education to students. A significant problem is the lack of an effective means of involving parents in the daily educational experience of their children. Parents often both have full-time jobs, or are single parents, such that it is difficult to continuously interact with teachers and school administrators. As a result, student relevant data including the negative and positive behavior of the students in class, the completion of homework, attendance, and general informational and other data may not become known to the parents in a timely manner. Consequently, parents are often not a position to help resolve their child's behavioral problems in a timely manner. What is needed therefore is a method that enables teachers and administrators to more easily report student relevant data to parents. This data and communication will be protected from errant disclosure by electronic signatures and/or pin codes. Similarly, teachers are often burdened with ever increasing student class loads, administrative duties, and paperwork. Consequently, teachers typically rarely contact parents to discuss problems which are developing, often due to the time and effort required to reach the parents. This leads to conflicts during progress report time when parents ask, “Why didn't I know about this sooner?” What is needed is method that enables teachers and administrators to inform parents more often and in a timely and meaningful way. An electronic process is the right solution.

Most schools maintain attendance records to track whether students attend school. It is known in the art to process these attendance records to generate alerts that are broadcast to the guardians for absent students. However, to the inventors' best knowledge and belief, such systems often simply result in the school district's telephone lines being inundated with responsive telephone calls from guardians shortly after the alerts are broadcast. Typically, such inundation occurs shortly after the broadcasts regarding student absences are sent out and continues for an hour or more thereafter. During this time, school personnel are bombarded with telephone calls from guardians to explain why their respective children were absent. This bombardment pulls those personnel away from their other work tasks. Given the consistent and intermittent patterns of these types of calls from guardians, the school personnel are rendered highly unproductive during this time. Furthermore, given some people's talkative/chatty natures, it is not uncommon for these telephone calls from the parents and guardians regarding their child's absence to branch out into other topics and this unexpected consumption of time further hinders the productivity of the school personnel.

With improvements in the capabilities of computer software and networks with respect to handling information storage and retrieval, various types of systems have arisen for automating, to various degrees, the management of information. Additionally, with the advent of various new types of communications, such as email and cell phones (and applications), the ability to effectively communicate information to interested individuals has likewise increased. In an effort to provide a solution to these problems, the inventors disclose methods and systems for intelligently notifying the first parties—parents and guardians. This solution is via email, cell phone applications, and automated telephone calls regarding an absence. This results in minimal burden on the third party personnel who manage attendance issues for the event. Importantly, by electronic signatures and/or pin codes, any confidential data is protected. This helps with the FERPA [Family Educational Rights and Privacy Act] and HIPAA [Health Insurance Portability and Accountability Act] privacy requirements. The new attendance system and method invented and shown here is believed to meet or exceed all concerns with HIPAA that is to protect the confidentiality and security of healthcare information and/or FERPA law that protects the privacy of student education records requirements. Commonly the event is a school session, the second parties are students who are supposed to attend the school session, the first parties are parents/guardians for the students, and the third party is a school employee who handles attendance issues.

Currently, little has been done to implement this type of automation in a way that is adapted to accommodate the information that must be managed in typical school systems. A standard school district can have thousands of students, ranging from kindergarten (and in some cases, even, publicly funded pre-school) through twelfth grade (K through 12). These students typically are dispersed/divided throughout different schools that are based on school level [such as elementary, middle, junior high, and high schools]. In larger towns or cities, multiple numbers of such schools can exist. This further divides up a multitude of students based on geographic location. For example, in a medical emergency, a school nurse or a soccer coach may suddenly need to have access to a student's medical information in order to appropriately diagnosis or treat the student. At the same time, they may need to access the contact information for the student's parent or guardian in such an emergency. In these cases, generally such information is kept in a “hard” file, such as a file folder or, more recently, in a basic computer database. Further, in some situations, a school official may need to contact the parents of certain groups of individuals to let to the parents of the students on a particular team know last minute changes: that a practice has been cancelled; or that there will be an early dismissal due to a loss of heat; or that here is an early dismissal and snow closing. Generally, such communication is carried out by manually telephoning the parents of the students or by some form of passive communication of the information, such as by posting the information on a website, radio and/or television stations. Here it becomes incumbent upon the parents to be aware that the information is being communicated in the first place.

### Problem Solved

Therefore, there is a need for an automated attendance monitoring system that not only counts and identifies tags or cards as students enter or leave a classroom, but that the system also has robust means for ensuring the integrity of the attendance data and that the system has the ability to prepare customized attendance reports for use by parents, education personnel, governmental agencies and others. Therefore, what is needed is a method that enables teachers and administrators to more easily report student relevant, accurate and current data to parents. What is needed is a method that enables teachers and administrators to inform parents more often and in a timely and meaningful way.

As such, it is desirable to have a convenient system that provides a daily awareness of attendance status that is reliable and available for the staff. One where Parents can have the ability to mark their own child absent or provide information about a late or early release. Such ability would enter straight to the school record via computer, cell/smart phone applications or landline telephone calls.

What is needed or desired is a system for managing critical student information that effectively manages the information for a wide variety of different groups of students. Desired is a system for easy access and dispersal/sending of current information while maintaining security and privacy of that information. A system that efficiently communicates, transfers, and tracks the student current information regarding a student's presence and tardiness plus allows meaningful interaction with parents and guardians. Plus, a system that provides unexpected results by providing trends of a student's presence or tardiness that can enable and feed a deeper review by counselors into behavior concerns that may be a red flag.

Institutions also need a system to send and receive information using a variety of messaging formats, systems, and message receiving devices. The messages may vary in their level of importance and this could affect the delivery methods and/or the nature and timing of any needed response to the message.

Also needed is a method and supporting apparatus for taking school attendance which may be adapted for use in schools with a large number of class rooms, laboratories and other areas that combine, distribute, and centralize the processing of large inputs of data. The new system must allow teachers to transmit this and receive this information to and from a central office computer at a school that is available to other education personnel, parents, guardians, governmental agencies. This information can be contained on secured cloud servers. These large quantities of attendance data and trends can be provided to principals, superintendents, and school boards for other uses. It can show trends to support further studies by grant funding. These studies can use attendance trends to plan counter measures to drug infiltration, gang activities, and even bullying tendencies. The attendance system provides trends and objective data that streamlines further investigation by counselors at a macro level (groups of students) or even pinpoints specific students for behavior investigations of potential red-flag subjects. The macro and individual data are constantly secured by the system to assure privacy and protection guided by the FERPA and HIPAA acts.

In addition, and currently a critical shortfall with many school systems is a system that goes further than just attendance. What is needed is a system that shows behavior shifts that need further investigation. By having attendance data, one can see negative tendencies or significant shifts in a student's attendance. This can further benefit counselors, teachers, parents and guardians to expand their watch for behavior shifts of individual students through interviews, surveying media such as Facebook™, chat lines, Twitter™, Snap Chat™, and text messages (i.e. red flags indicating a change in one's environment and potential need for counseling or behavior analysis). This attendance data can also be used by superintendents to correlate attendance shifts with gang behavior, bullying, or other matters which can be addressed with planning future changes for the schools or even getting grants to combat negative shifts in the schools. All from absentee data.

### Prior Art

A U.S. Pat. No. 8,543,086 entitled “System for schools managing SMS credits using mobile reverse charge technology” was issued to Fortunatow in 2013. It demonstrated a method of billing or charging a receiver for a mobile communication being message, that allows the receiver to receive messages as part of a service, the receiver being billed directly by the telecommunications carrier who then in turn aggregates a revenue share based on messages sent to receivers, who then in turn pay a percentage of the revenue share to the premium SMS aggregator. This invention fails to show the steps and simple/more efficient process of the Wilkinson technology. Another U.S. Pat. No. 8,353,705 entitled “Attendance tracking system” was issued to Dobson et al. in 2013 which taught an automated attendance monitoring system is disclosed. The system includes (i) identification tags, (ii) scanners, (iii) at least one server, (iv) handheld computing devices for use by attendance trackers, and (v) software running on the server for receiving and managing the attendance data received from the scanners, and for generating attendance reports. This invention fails to show the verification steps and more efficient/economically feasible process of the Wilkinson technology. Wilkinson provide specific security and accountability of whose custody the child is entrusted.

A United States Patent Application was published as No. US2012/02968 interactive comments capability entitled “System and method for performing substitute fulfillment” by Thompson et al. in 2012. This showed a system and method for automating the performance of substitute fulfillment. This invention fails to show the steps and simple/more efficient process of the Wilkinson technology. It is much more laborious interface with office and teaching professionals is required by Thompson as compared to the Wilkinson invention. A United States Patent Application was published as U.S. Pat. No. 8,180,274 entitled “System for managing and messaging critical student information” was issued to Bender in 2012 that provided a system for managing critical student information is disclosed generally comprising storing information associated with individual students, such as important medical information or contact information for the student's parent or guardian, and providing different authorized users, permission to access the information and/or send messages for particular students. The Bender idea merely addresses an internet connective system and fails to address the wide provisions shown by Wilkinson, et al.

A U.S. Pat. No. 7,684,548 entitled “Notification and response system with attendance tracking features” was issued to Rodkey et al. in 2010 that taught and demonstrated a notification and response system utilizes an administrator interface to transmit an attendance message from an administrator to a contact devices for guardians, employees, and students associated with an institution. The system comprises a dynamic information database that includes guardian, employee and student contact data, priority information, and response data. Rodkey is a notification system and lacks most of the interactive features offered by Wilkinson, et al. A United States Patent Application was published as No. US2007/0292835 entitled “Method for reporting student relevant data” was initiated by Hartman et al. in 2007. This showed a method for reporting student relevant data to parents that provides secure access by a validated user over a computer network to forms that enable the user to associate student relevant data categories with a particular student. The computer network enables selective display of the forms on a user's terminal. Hartman provides communication but lacks verification and historical data taught by Wilkinson, et al.

A United States Patent Application was published as No. US 2003/0167193 entitled “Attendance monitoring system” was applied for by Jones et al. in 2003. It taught an invention that relates to an attendance monitoring system. More particularly, the invention is directed to a system that provides to an employer an instant visual representation of an employee's daily attendance (including that for the present day), attendance history (which is an indicator of reliability), available paid time off, current vacation schedule, assignment status, training status, and the like. Jones et al. is primarily a monitoring system and lacks the interactive features and feedback to parents/guardians of Wilkinson. A U.S. Pat. No. 6,173,153 entitled “Method and apparatus for taking school attendance” was issued to Bittman in 2001 which demonstrates an apparatus for taking school attendance includes a central office computer 101 interfaced with a plurality of attendance telephones 102. Bittman is an attendance system lacking the interactive feedback of Wilkinson, et al.

Another U.S. Pat. No. 5,956,696 entitled “Attendance registration system by radio link” issued to Guryel in 1999. This shows a method of electronically registering student attendance data includes storing a plurality of student names in a central collection station. The stored student names are downloaded and stored to at least one portable data collection device. Guryel again is an attendance system lacking the interactive feedback of Wilkinson, et al. Finally, as prior art, a U.S. Pat. No. 3,740,725 entitled “Automated attendance accounting system” was issued to Fletcher et al. in 1973. Here is shown and demonstrated an automated accounting system useful for applying data to a computer from any or all of a multiplicity of data terminals is disclosed. Fletcher shows an antiquated system that fails to anticipate the modern telephone/internet/cellphone and application system shown by the Wilkinson system and process.

### SUMMARY OF THE INVENTION

This invention is an Interactive and Real-Time Absentee Reporting and Flagging System for Schools, Parents and Other Institutions. The preferred embodiment of the Interactive and Real-Time Absentee Reporting and Flagging System for Schools, Parents and Other Institutions is comprised of: (a) an existing absentee reporting system or new reporting system; (b) a portal means for communicating and exchanging information like a call-in website by email and/or cellphone application and/or telephone; (c) a log-in process to choose/and-or create a file for a specific child; (d) a review file of recent absentees and/or tardiness; (e) a manner to enter and/or edit a reason code for the absentee or tardiness; (f) a means for securely signing (electronic signature or pin codes or the like) for acknowledging absenteeism and other school forms; and (g) an interactive comments capability (like email comments; text comments through a smartphone application; an email a sound recording; email a video response; attach recorded comments through a smartphone application; and attach videoed comments through a smartphone application) wherein the Interactive and Real-Time Absentee Reporting and Flagging System for Schools, Parents and Other Institutions may be accessed on a real time basis for interaction between school systems (teachers, secretary and administrators) with the parent, guardian and governmental institutions. An alternative embodiment is the system described above and further comprised of after school and curricular activities wherein sponsors or coaches can interact and advise parents/guardians, etc. of the location and presence of the student at such extracurricular activities. In addition, the Interactive and Real-Time Absentee Reporting and Flagging System—short form and an Interactive and Real-Time Absentee Reporting and Flagging System—long form provides the data to a digital data to analog conversion device which signals a controller to district school map or other devices such as large red/yellow/green light board, thermometer, audio system (that plays message or music pre-determined for absenteeism alerts to teachers in lounge or students in a cafeteria or gymnasium, an absenteeism report board, a school report board etc. that all use a timer device that blinks light on/off for example. Plus, the Absentee System 30, 30A provides initial data to a nurse and counselor that can print an automatic/advance clearance sheets for absentee sheets or illness sheet that alert coaches and other sponsor plus permit them to seek medical (hospital) care for at risk students [diabetics, seizures, ADHD, blood thinners, heart ailment] but do not violate HIPAA and FERPA since parent/guardian approval was obtained through the absentee system. It also permits printing a counselor flag report based on other data in the absentee system.

### Objects and Advantages

There are several objects and advantages of the

Interactive and Real-Time Absentee Reporting and Flagging System for Schools, Parents and Other Institutions. There are currently no known interactive systems or processes for absentee tracking and reporting that are effective at providing the objects of this invention.

The advantages and benefits of the Interactive and Real-Time Absentee Reporting and Flagging System for Schools, Parents and Other Institutions are:

| Item | Description |
|---|---|
| 1 | Decrease liability for the school |
| 2 | Saves paper - students will no longer have to |
| | physically bring in the note (documentation - |
| | Dr.'s note, funeral, court, etc . . . . ) to the |
| | school nor risk losing the documentation |
| 3 | Save time for secretaries, teachers, parents, |
| | students and administration |
| | A. Parents won't have to call or write notes |
| | B. Students won't have to go to office if |
| | parents participate and wait in line at |
| | the attendance office |
| | C. Secretaries won't have to wait on as many |
| | individual students |
| | D. Administrators can look at compounded |
| | records * hopefully, based on parent |
| | participation, attendance records will be |
| | more accurate. |
| 4 | Better Security |
| | A. Direct communication Parent <-> School and |
| | vice versa. |
| | B. Electronic signatures and/or pins to meet |
| | or exceed HIPPA and FERPA requirements. |
| | C. More accountability about student's |
| | whereabouts and who is picking them up. |
| | D. More accountability for older students to |
| | be where they are supposed to be. |
| | E. Better timely notification to parents |
| 5 | Better documentation: more efficient and |
| | accurate. |
| 6 | The potential to assist non-school community |
| | services |
| 7 | Children are better protected |
| 8 | Parents gain more efficiency, freedom and |
| | empowerment over children's absence |
| | accountability. |
| 9 | Saves learning time - Kids don't have to wait |
| | in line to check in with attendance or get |
| | pass slips. |
| 10 | Parents are happier/staff happier promoting |
| | better working conditions. |
| 11 | Allows parents to feel more secure. |
| 12 | Provides more convenience for the people (all |
| | parties) to communicate in a less social |
| | setting which according to statistics, will |
| | increase the participation. (The parents/ |
| | guardians can email or upload, etc. without |
| | needing to talk to anyone). |
| 13 | Provides attendance data and trends to target |
| | changes of individual students that merits |
| | further tracking and investigation. This may |
| | show trends of risky, irresponsible, or |
| | socially inappropriate behavior including |
| | drugs, bullying or gang related changes to |
| | that student's environment which is forcing |
| | negative reactions or even “red flag” |
| | tendencies. |
| 14 | Provides attendance data and trends to target |
| | changes of groups of students that indicates |
| | a need for further tracking and |
| | investigation. This may show trends of |
| | risky, irresponsible, or socially |
| | inappropriate behavior including drugs or |
| | gang influences that are negative in nature. |
| 15 | Provides easy access to attendance trends by |
| | school or school districts to |
| | superintendents. The measurable/objective |
| | trends in the data may bolster requests for |
| | district, state, and/or federal funds by |
| | grants to study the behavior changes and help |
| | set plans or counter measures to reverse |
| | negative trends and/or even understand the |
| | bases of positive trends in order to |
| | replicate the trends at other schools or |
| | districts. |

Finally, other advantages and additional features of the present Interactive and Real-Time Absentee Reporting and Flagging System for Schools, Parents and Other Institutions will be more apparent from the accompanying drawings and from the full description of the device. For one skilled in the art of absentee tracking and reporting and in the art of interactive communications, it is readily understood that the features shown in the examples with this product are readily adapted to other types of tracking and reporting systems for various institutions—education, government, institutional and the like.

### DESCRIPTION OF THE DRAWINGS—FIGURES

The accompanying drawings, which are incorporated in and constitute a part of this specification, illustrate an embodiment of the Interactive and Real-Time Absentee Reporting and Flagging System for Schools, Parents and Other Institutions that is preferred. The drawings together with the summary description given above and a detailed description given below serve to explain the principles of the Interactive and Real-Time Absentee Reporting and Flagging System for Schools, Parents and Other Institutions. It is understood, however, that the Interactive and Real-Time Absentee Reporting and Flagging System for Schools, Parents and Other Institutions is not limited to only the precise arrangements and instrumentalities shown.

FIGS. 1A and 1B are sketches of the Interactive and Real-Time Absentee Reporting and Flagging System for Schools, Parents and Other Institutions and Simple block diagrams of short and long systems.

FIGS. 2A and 2B are sketches of the Parent Account Setup Form: Short Form Version as noted.

FIG. 3 is a flowchart of the Short Form: Parent Account—Absence Entry.

FIG. 4 is a flowchart of Short Form: Phone Call Absence.

FIG. 5 is an Example Reason Codes (For School/Parents) for a Short Form.

FIG. 6 is a Sample of Absence Record for a Short Form.

FIG. 7 is a Short Form: School Account by the Old Fashioned Way.

FIG. 8 is a Short Form: School Entry Account.

FIG. 9 is a Short Form Signature Required Forms Account.

FIG. 10 is a Parent Account Setup Form: Long Form Version.

FIG. 11 is a Long Form: Parent Account—Absence Entry.

FIG. 12 is a Long Form Phone Call Absence flowchart.

FIG. 13 is a Sample of Absence Record for a Long Form.

FIG. 14 is a Long Form: School Account done by the Old Fashioned Way.

FIG. 15 is a Long Form: Teacher flowchart for a Long Form.

FIG. 16 is a Possible Reason Codes table (For School/Parents)—Long Form.

FIG. 17 is a flowchart for a Long Form: Nurse Page—this needs to have access to everyone.

FIG. 18 is a flowchart for a Long Form: Extra Curricular activities.

FIG. 19 is an Example of Long Form: School Entry Accounts.

FIG. 20 is a Long Form: School Entry Account Teacher Page (Page A).

FIG. 21 is an Example of a Long Form: Signature Required Forms Account (Page B).

FIG. 22 is a list of Examples of Other Usable Agencies.

FIG. 23 is a Short/Long Form District Level.

FIG. 24 is a Long Form Counselor Entry Page.

FIG. 25 is a Long Form Counselor Office Emotional Stability flow chart.

FIGS. 26A and 26B are sketches of nurse and counselors providing advanced medical release sheets and red flag reports from the Interactive and Real-Time Absentee Reporting and Flagging System for Schools, Parents and Other Institutions.

FIGS. 27A through 27C are sketches of the superintendent with a school district board, a teacher lounge with an attendance board and a gymnasium with an attendance board all provided control from a computer and the Interactive and Real-Time Absentee Reporting and Flagging System for Schools, Parents and Other Institutions.

### DESCRIPTION OF THE DRAWINGS—REFERENCE NUMERALS

The following list refers to the drawings:

TABLE B
Reference numbers

| Ref # | Description |
|---|---|
| 30 | Interactive and Real-Time Absentee Reporting and |
| | Flagging System - short form 30 |
| 30A | Interactive and Real-Time Absentee Reporting and |
| | Flagging System - long form 30A |
| 31 | Parent Account Setup Form: Short Form Version 31 |
| 31A | Details of Parent Account Setup Form: Short Form |
| | Version 31A |
| 33 | Short Form: Parent Account-Absence Entry 33 |
| 34 | Short Form: Phone Call Absence 34 |
| 35 | Example Reason Codes (For School/Parents) for a Short |
| | Form 35 |
| 36 | Sample of Absence Record for a Short Form 36 |
| 37 | Short Form: School Account by the Old Fashioned Way 37 |
| 38 | Short Form: School Entry Account 38 |
| 39 | Short Form Signature Required Forms Account 39 |
| 40 | Parent Account Setup Form: Long Form Version 40 |
| 41 | Long Form: Parent Account - Absence Entry 41 |
| 42 | Long Form Phone Call Absence flowchart 42 |
| 43 | Sample of Absence Record for a Long Form 43 |
| 44 | Long Form: School Account done by the Old Fashioned |
| | Way 44 |
| 45 | Long Form: Teacher flowchart for a Long Form 45 |
| 46 | Possible Reason Codes table (For School/Parents) - Long |
| | Form 46 |
| 47 | Long Form: Nurse Page 47 |
| 48 | Long Form: Extra Curricular activities 48 |
| 49 | Example of Long Form: School Entry Accounts 49 |
| 50 | Long Form: School Entry Account Teacher Page (Page A) |
| | 50 |
| 51 | Example of a Long Form: Signature Required Forms |
| | Account (Page B) 51 |
| 52 | list of Examples of Other Usable Agencies 52 |
| 53 | Short/Long Form District Level 53 |
| 55 | Long Form Counselor Entry Page 55 |
| 57 | Long Form Counselor Office Emotional Stability flow |
| | chart 57 |
| 60 | digital data to analog conversion device 60 |
| 61 | controller 61 to district school map 62 or other rating |
| | output device 90 |
| 62 | school map 62 |
| 65 | school locations 65 |
| 66 | green (under 6% absences)/yellow (6 to 8% absences)/ |
| | red (over 10% absences) lights 66 (LED) for the |
| | grading period |
| 70 | timer device 70 blinks light on/off for 15 seconds out |
| | of every 5 minutes for first 3 days after bulb has |
| | changed color code |
| 80 | Automatic/advance clearance sheets 80 by Nurses for |
| | absentee sheets or illness sheet that alert coaches and |
| | other sponsor plus permit them to seek medical |
| | (hospital) care for at risk students [diabetics, |
| | seizures, ADHD, blood thinners, heart ailment] but do |
| | not violate HIPAA and FERPA since parent/guardian |
| | approval was obtained through the absentee system 30, |
| | 30A |
| 81 | printer 81 connected to terminal 82 |
| 82 | computer terminal 82 connected to absentee system |
| | 30, 30A |
| 83 | counselor flag report 83 based on other data in the |
| | absentee system 30, 30A |
| 83 | teacher lounge 83 |
| 90 | output device 90 such as large red/yellow/green light |
| | board, thermometer, audio system (that plays message or |
| | music pre-determined for absenteeism alerts to teachers |
| | in a lounge or students in a cafeteria or gymnasium |
| 92 | absenteeism report board 92 |
| 93 | school report board 93 |
| 94 | gymnasium/auditorium 94 for students |
| 95 | counselor 95 |
| 97 | detective, FBI, and local authorities 97 |
| 98 | superintendent 98 |
| 100 | nurse 100 |

### DETAILED DESCRIPTION OF PERFERRED EMBODIMENT

The present development is an Interactive and Real-Time Absentee Reporting and Flagging System for Schools, Parents and Other Institutions. More particularly, this invention relates to systems and methods for tracking the location of individuals, such as students entering or leaving a school or classroom and for managing critical student information. The present invention also relates to methods of reporting student behavior, and in particular a method of reporting student relevant data including behavior to parents and interested private/government institutions over a computer network. This invention relates to an attendance monitoring system. More particularly, the invention is directed to a system that provides to a school system, parents or interested private/government institutions an instant visual representation of a student's daily attendance (including that for the present day) and attendance history (which is an indicator of potential concerns). The present embodiments further relate to an immediate response information or emergency system for guardians, employees, and students associated with an institution, such as a school or a school system relating to student daily attendance which can relate to tracking attendance of a child in case of an emergency situation or knowing where the child is while in an institution or school system. This invention relates to data logging systems, and in particular, to systems for logging or registering items of data related to persons. It is, although not exclusively, adapted for use as a classroom roll-taking system, for recording the presence or absence of pupils or students, their test results and other such data.

This relates further to a significant improvement to an attendance system that can show behavior shifts that may need or should merit further investigation. By having attendance data at one's fingertips, one can see negative tendencies or significant shifts in a student's attendance. This can benefit counselors, teachers, parents and guardians to expand their “watch for behavior shifts” of individual students. A shift can merit other investigations through interviews, surveying media [such as Facebook™, chat lines, Twitter™, Snap Chat™, and text messages (i.e. red flags indicating a change in one's reaction to their personal environment and potential need for counseling or behavior analysis). This significant improvement in attendance data can also be used by principals or superintendents to correlate attendance shifts with trends of risky, irresponsible, or socially unacceptable behavior including gang behavior, bullying, or other matters which can be addressed with planning future changes for the schools or even getting grants to combat negative shifts in the schools. All from absentee data.

Taught here are the ways an absentee reporting system may be improved to have a fully interactive capability. This may be an adaptive system tied in to existing absentee systems or a fully new and expanded system to anticipate and interactively report the curricular and extracurricular activities—hence permitting the student's real time location and presences at events to be known by educational persons, parents and guardians, and other governmental agencies.

The advantages for the Interactive and Real-Time Absentee Reporting and Flagging System 30 for Schools, Parents and Other Institutions listed above in the introduction. Succinctly the benefits are that the system:
1. Decrease liability for the school
2. Saves paper and students will no longer have to physically bring in the note(documentation—Dr.'s note, funeral, court, etc. . . . ) to the school nor risk losing the documentation
3. Save time for secretaries, teachers, parents, students and administration
   A. Parents won't have to call or write notes
   B. Students won't have to go to office if parents participate and wait in line at the attendance office
   C. Secretaries won't have to wait on as many individual students
   D. Administrators can look at compounded records hopefully, based on parent participation, attendance records will be more accurate.
4. Better Security
   F. Direct communication Parent to School and vice versa.
   G. Electronic signatures and/or pins to meet or exceed HIPPA and FERPA requirements.
   H. More accountability about student's whereabouts and who is picking them up.
   I. More accountability for older students to be where they are supposed to be.
   J. Better timely notification to parents
5. Better documentation: more efficient and accurate
6. The potential to assist non-school community services
7. Children are better protected
8. Parents gain more efficiency, freedom and empowerment over children's absence accountability.
9. Saves learning time—Kids don't have to wait in line to check in an attendance or get pass slips.
10. Parents are happier/staff happier promoting better working conditions.
11. Allows parents to feel more secure.
12. Provides more convenience for the people (all parties) to communicate in a less social setting which according to statistics, will increase the participation. (The parents/guardians can email or upload, etc. without needing to talk to anyone.)
13. Provides attendance data and trends to target changes of individual students that merits further tracking and investigation. This may show trends of risky, irresponsible, or socially inappropriate behavior including drugs, bullying or gang related changes to that student's environment which is forcing negative reactions or even “red flag” tendencies.
14. Provides attendance data and trends to target changes of groups of students that indicates a need for further tracking and investigation. This may show trends of risky, irresponsible, or socially inappropriate behavior including drugs or gang influences that are negative in nature.
15. Provides easy access to attendance trends by school or school districts to superintendents. The measurable/objective trends in the data may bolster requests for district, state, and/or federal funds by grants to study the behavior changes and help set plans or counter measures to reverse negative trends and/or even understand the bases of positive trends in order to replicate the trends at other schools or districts.

The preferred embodiment of the Interactive and Real-Time Absentee Reporting and Flagging System for Schools, Parents and Other Institutions is comprised of: (a) an existing absentee reporting system or new reporting system; (b) a portal means for communicating and exchanging information like a call-in website by email and/or cellphone application and/or telephone; (c) a log-in process to choose/and-or create a file for a specific child; (d) a review file of recent absentees and/or tardiness; (e) a manner to enter and/or edit a reason code for the absentee or tardiness; (f) a means for securely signing (electronic signature or pin codes or the like) for acknowledging absenteeism and other school forms; and (g) an interactive comments capability (like email comments; text comments through a smartphone application; an email a sound recording; email a video response; attach recorded comments through a smartphone application; and attach videoed comments through a smartphone application) wherein the Interactive and Real-Time Absentee Reporting and Flagging System for Schools, Parents and Other Institutions may be accessed on a real time basis for interaction between school systems (teachers, secretary and administrators) with the parent, guardian and governmental institutions. An alternative embodiment is the system described above and further comprised of after school and curricular activities wherein sponsors or coaches can interact and advise parents/guardians, etc. of the location and presence of the student at such extracurricular activities. In addition, the Interactive and Real-Time Absentee Reporting and Flagging System—short form 30 and an Interactive and Real-Time Absentee Reporting and Flagging System—long form 30A provides the data to a digital data to analog conversion device 60 which signals a controller 61 to district school map 62 or other devices 90 such as large red/yellow/green light board, thermometer, audio system (that plays message or music pre-determined for absenteeism alerts to teachers in a lounge or students in a cafeteria or gymnasium 94, an absenteeism report board 92, a school report board 93 etc. that all use a timer device that blinks light on/off for example. Plus, the Absentee System 30, 30A provides initial data to a nurse and counselor that can print an automatic/advance clearance sheets 80 for absentee sheets or illness sheet that alert coaches and other sponsor plus permit them to seek medical (hospital) care for at risk students [diabetics, seizures, ADHD, blood thinners, heart ailment] but do not violate HIPAA and FERPA since parent/guardian approval was obtained through the absentee system 30, 30A. It also permits printing a counselor flag report 83 based on other data in the absentee system 30, 30A.

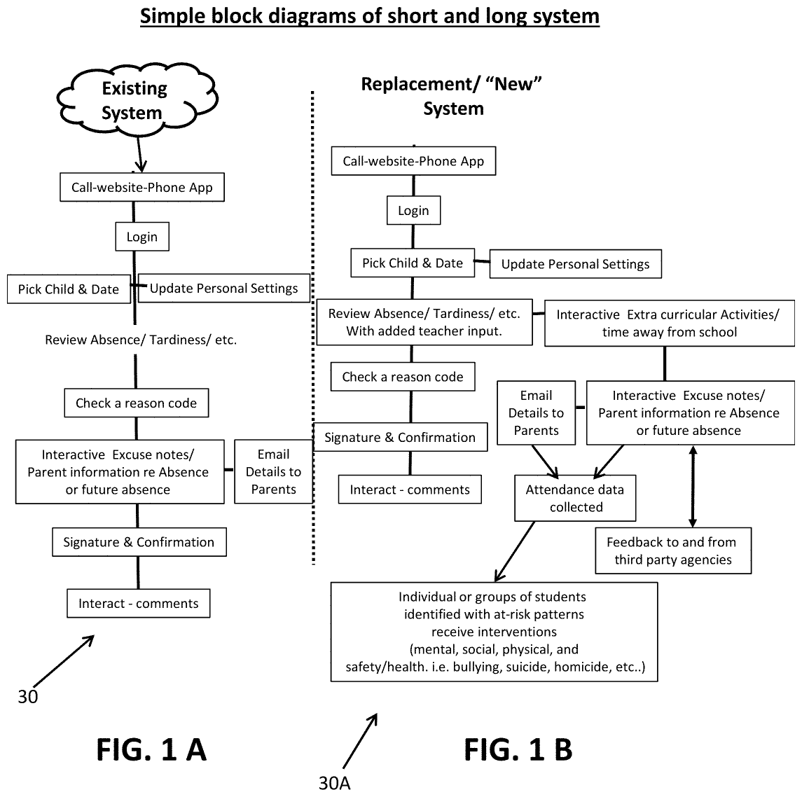

There is shown in FIGS. 1-27 a complete description and operative embodiment of the Interactive and Real-Time Absentee Reporting and Flagging System for Schools, Parents and Other Institutions. In the drawings and illustrations, one notes well that the FIGS. 1-27 demonstrate the general configuration, concept and use of this system/process. The various example uses are in the operation and use section, below.

The accompanying drawings, which are incorporated in and constitute a part of this specification, illustrate an embodiment of the Interactive and Real-Time Absentee Reporting and Flagging System for Schools, Parents and Other Institutions 30, 30A that is preferred. The drawings together with the summary description given above and a detailed description given below serve to explain the principles of the Interactive and Real-Time Absentee Reporting and Flagging System for Schools, Parents and Other Institutions 30, 30A. It is understood, however, that the Interactive and Real-Time Absentee Reporting and Flagging System for Schools, Parents and Other Institutions 30, 30A is not limited to only the precise arrangements and instrumentalities shown. Other examples of the Interactive and Real-Time Absentee Reporting and Flagging System for Schools, Parents and Other Institutions and in the art of interactive communications, it is readily understood that the features shown in the examples with this product are readily adapted to other types of tracking and reporting systems for various institutions—education, government, institutional and the like to be within the scope and spirit shown here.

FIGS. 1A and 1B are sketches of the Interactive and Real-Time Absentee Reporting and Flagging System 30, 30A for Schools, Parents and Other Institutions and Simple block diagrams of short and long systems. Shown here are the Interactive and Real-Time Absentee Reporting and Flagging System—a short form 30 combining and interfacing into existing systems and Interactive and Real-Time Absentee Reporting and Flagging System—and a long form 30A for totally new systems. The specific steps and sub-steps are self-explanatory from the detailed drawings and description.

The Short Form Option 30 combining and interfacing into existing systems is further described as: The short form will basically allow schools the ability to keep the parents signature on file. They will be able to keep track of all student absences reported by the parents. The big advantage or perk with choosing the short form is that the liability is taken off the school and placed squarely onto to parents and students for absences. Also offered is the ability to upload any form they may need to get signatures of parents (i.e. medical release, permission slips, free and reduced lunch, etc.). This option is secured since only school administration and select secretaries and parents will have access to this private information. The process must include:
A. A way for parents to set up a school account;
B. A way for parents to submit and review absences (website, app, and phone-in);
C. A way for parents to cancel an absence that hasn't come to date yet;
D. A way for parents to say who will pick up the student and school can see that information;
E. A way for parents and the school to scan in notes;
F. A way for the school to enter an old fashioned absence “bring in note”;
G. A way for the school to correct parent account and or re-set password;
H. A way for the school to review absence (Absence chart); and
I. A pass slip to be generated for students recorded for early release or late entry.

The Long Form Option 30A for a totally new system is further comprised and described as: If the client chooses the long form option they will receive everything the short program offers plus the ability for the daily school attendance to be recorded as well as extracurricular activities. Teachers, coaches, advisors, nurse and anyone involved in extracurricular activities could be involved in this process. This Long Form Option 30A for a totally new system must include:
A. All the short program options;
B. The initial parent form (setting up the account) must include a way for parents to mark “want information about specific extracurricular activities. (i.e., boys' basketball, girls track, freshman choir, etc.) Parents can change whether they want to receive info. at any time;
C. The daily school attendance (during regular hours for each period to be recorded);
D. The ability for courtesy (calls, text or email) to be sent to parents if their child is marked absent after a specified time;
E. Also school has the ability to mark a child absent for extended time due to illness, family crisis, pregnancy, etc. . . . (pop-up notice or email about long term date approaching for student to return or time extended);
F. Option for attendance to be taken during extracurricular activities;
G. Option for notices to be sent to parents about extracurricular activities (i.e., practice times, departures, arrivals, cancelations, etc.);
H. Full attendance records including parents recorded absences and school absences combined or separate; and
I. A way for the nurse to mark if a student is sent home early and optional pass slip generated and or email/text sent to current period teacher, attendance secretary and parent.

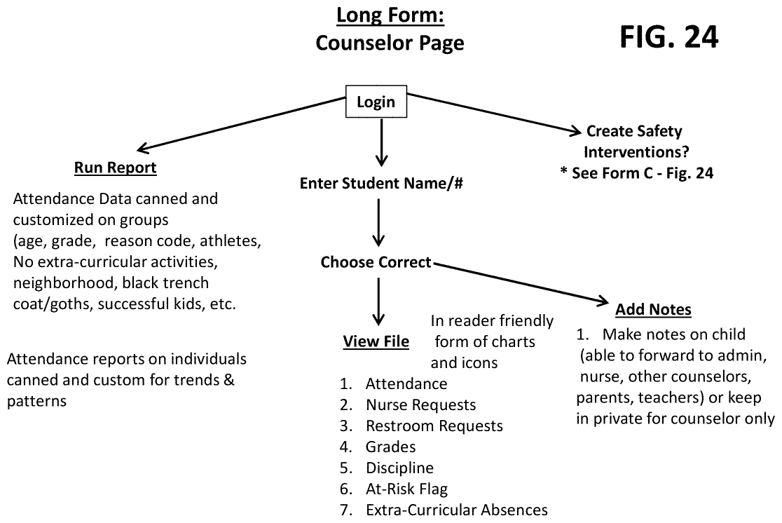

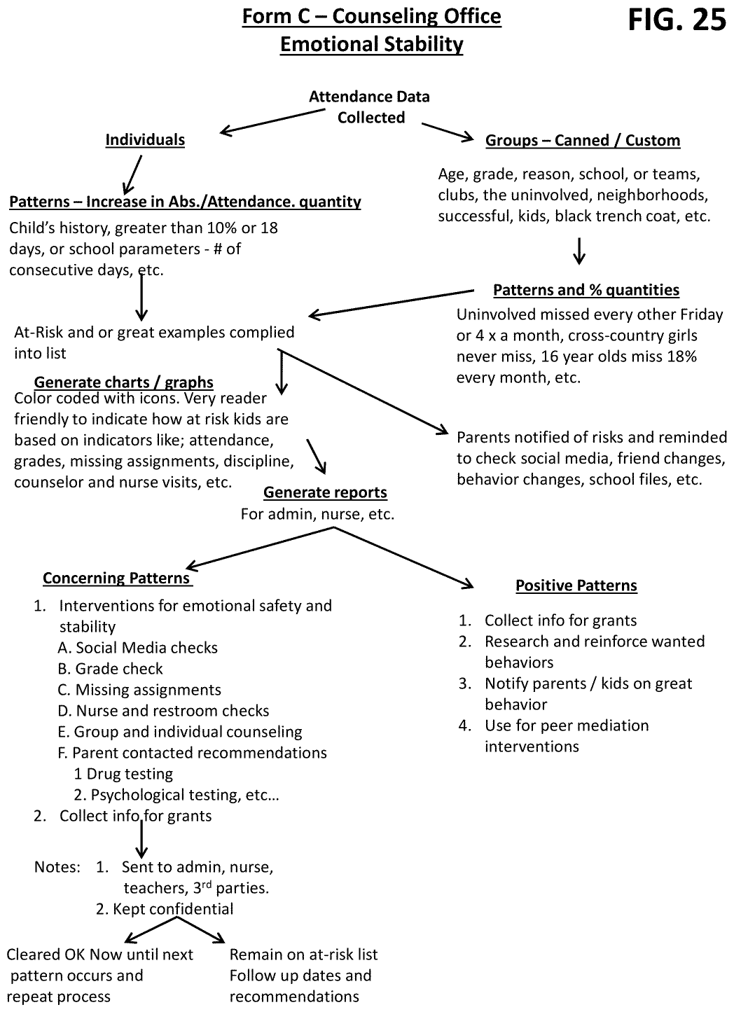

Telephone cellular and smart phone applications includes and is comprised as:
A. Parents can use website/phone app or Call-In or let kids bring in note.
B. Parents Pick going to a website or using a smartphone application.
C. Parents Login with electronic signature and/or a pin to the absence systems and form by signing “in” (various types discussed herein).
D. Parents consider and choose options to change personal account (Account Form) or Pick a Child (if parent has multiple children).
E. System already has Documentation—Dr's note or court note. Parents still need to have an option for the student/kids to bring in the documentation for entry into the system and obtain approval instead of just a scan/pdf of a note.
F. Once the Attendance data is collected, individual and/or groups of students identified with at-risk patterns receive interventions (mental, social, physical, and safety/health i.e. bullying, suicide, homicide, etc.) can be made.
G. If there is intervention, the student is recommended for the counselor to be notified and brought into for more in-depth analysis (See FIGS. 24 and 25).
H. This more comprehensive part of the system only goes to teacher program if school buys long form option. With the long form options in place, Teachers can also get access to short form as well.
I. Also when school records are updated, there is an option for pass slip/excuse note to be generated for the student to receive and carry.
J. If parents call in a “late entry and/or an early release” there needs to be an option for the pass slip.
   In all cases, the long or short form system 30, 30A, the interactive comments capability include, for example and not limitations, the email comments; text comments through a smartphone application; an email a sound recording; email a video response; attach recorded comments through a smartphone application; and attach videoed comments through a smartphone application.

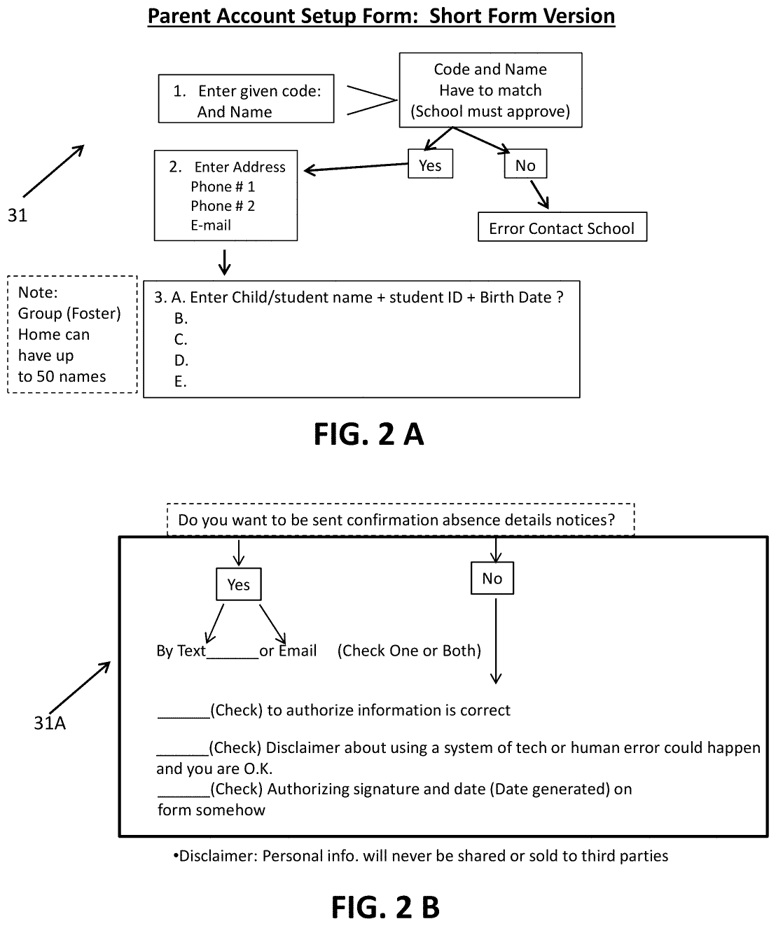

FIGS. 2A and 2B are sketches of the Parent Account Setup Form: Short Form Version 31 as noted. The specific steps and sub-steps are self-explanatory from the detailed drawings and description. One notes several points: a Group (Foster) Home can have up to 50 names as opposed to a basic family; if one wants to be sent confirmation absence details notices, they may by text messages, electronic mail or both; and if one doesn't choose a notice, the person must answer a disclaimer of notice, etc. Of special importance is the disclaimer that Personal info. will never be shared or sold to third parties.

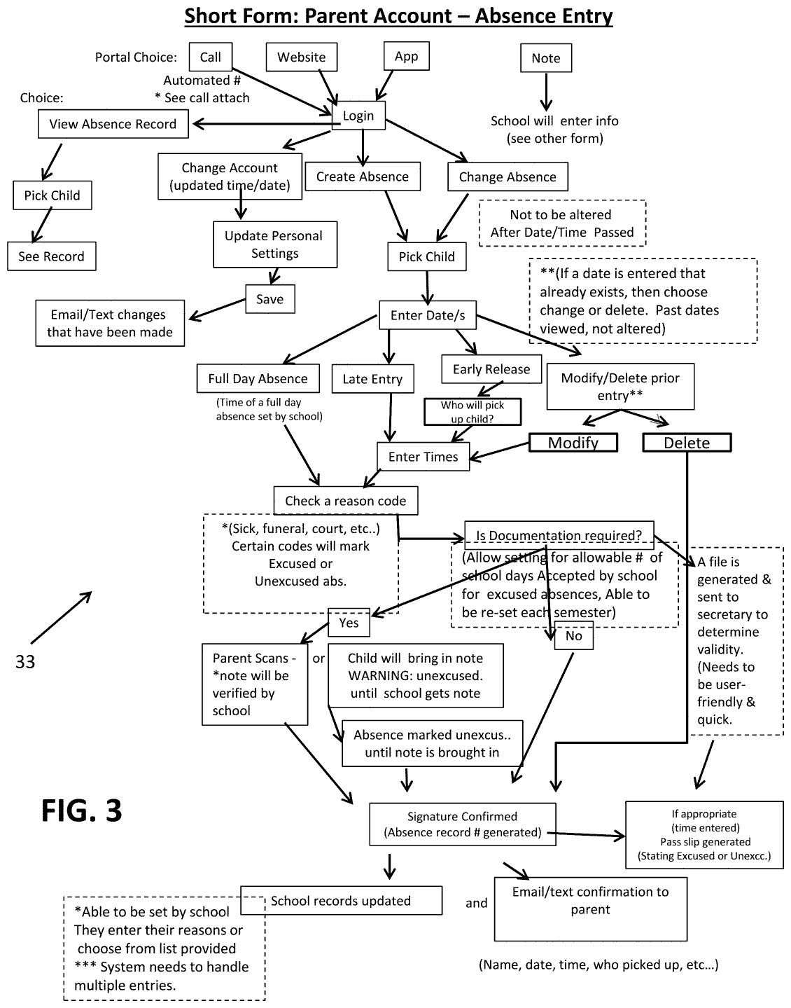

FIG. 3 is a flowchart of the Short Form: Parent Account—Absence Entry 33. The specific steps and sub-steps are self-explanatory from the detailed drawings and description. One notes the portal means for communicating and exchanging information include telephone calls, website/email, or smartphone applications. Also, one notes if a date is entered into the system that already exists, then one must choose to change or delete. Here, past dates may be viewed but not altered by parents. Shown also are sample certain reason codes like: sick, funeral, court, etc. and codes will be marked Excused or Unexcused absence. There is also a setting that permits establishing for the allowable number of school days accepted by school for excused absences, before documentation is needed and these numbers are able to be re-set each semester. This documentation is in a file that is generated (user-friendly and quick) and sent to a school administrator/secretary to determine validity. Finally, the electronic mail or text confirmation to parent relays the child's name, date, time, who picked up, etc.

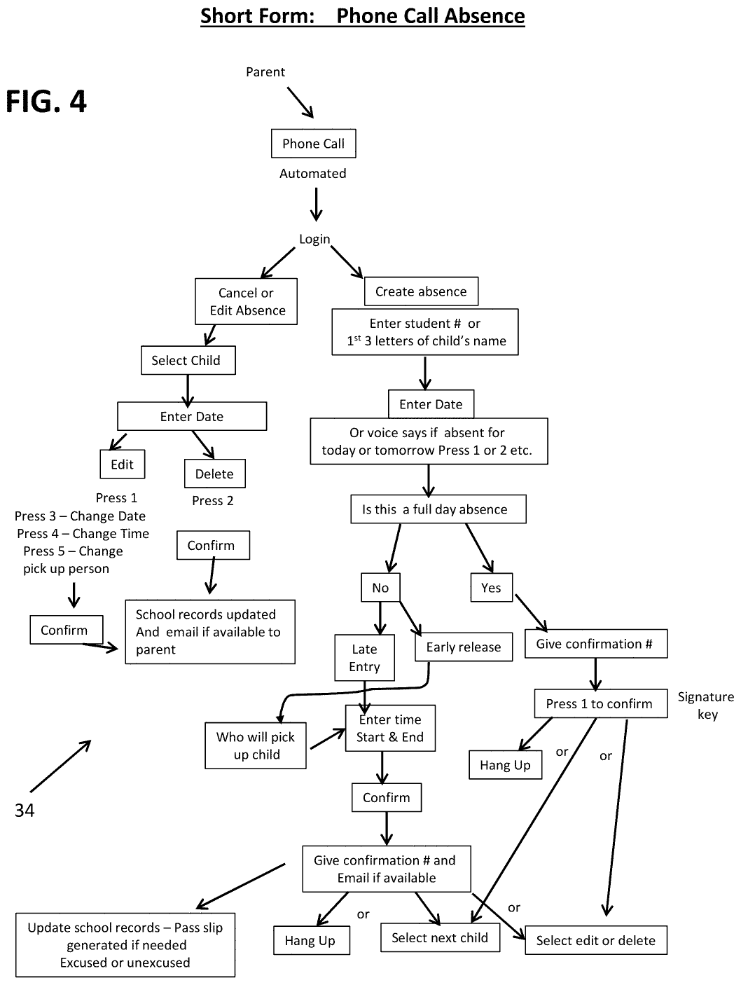

FIG. 4 is a flowchart of Short Form: Phone Call Absence 34. The specific steps and sub-steps are self-explanatory from the detailed drawings and description.

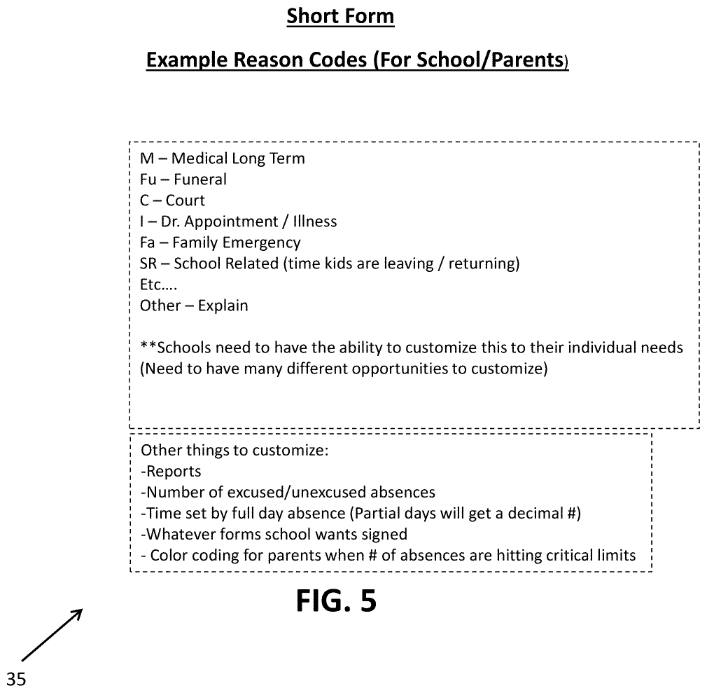

FIG. 5 is an Example Reason Codes (For School/Parents) for a Short Form 35. The specific steps and sub-steps are self-explanatory from the detailed drawings and description. Reason codes, for example and not as a limitation are: M—Medical Long Term; Fu—Funeral; C—Court; I—Dr. Appointment/Illness; Fa—Family Emergency; SR—School Related (provides time kids are leaving/returning) and O—other reasons—space to explain. The schools have the ability to customize this to their individual needs with different opportunities to customize reports; number of excused/unexcused absences; time set by full day absence (Partial days); whatever forms school wants signed; and color coding for parents when the number of absences are hitting critical limits.

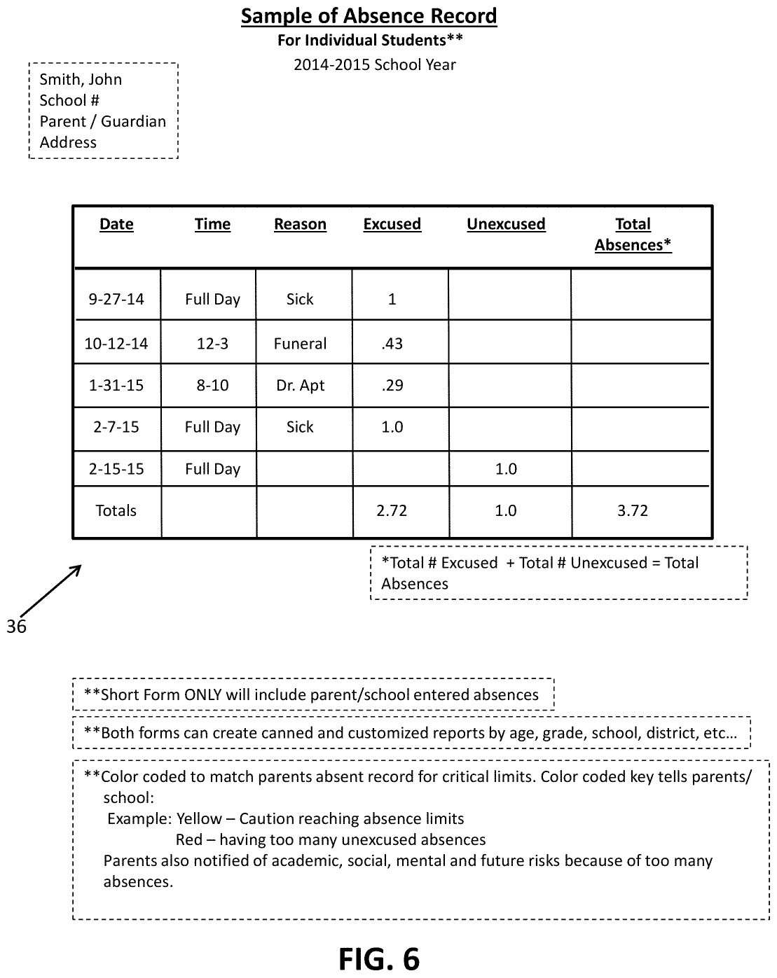

FIG. 6 is a Sample of Absence Record for a Short Form 36. The specific steps and sub-steps are self-explanatory from the detailed drawings and description. Short Form ONLY will include parent/school entered absences. Form can create standard (canned) and customized reports by age, grade, school, district, etc. Forms can be color coded to match parent's absence record for critical limits. Color coded key tells parents/school: (example yellow-caution reaching absence limits, red-having too many unexcused absences). Parents also notified of academic, social, mental, and future risks because of too many absences.

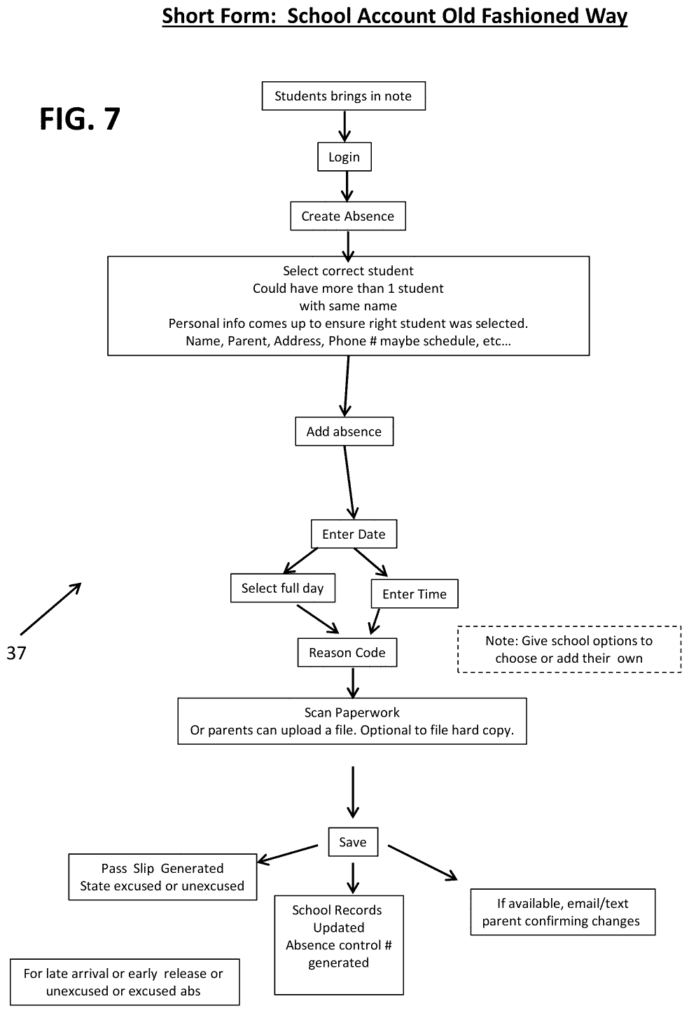

FIG. 7 is a Short Form: School Account by the Old Fashioned Way 37. The specific steps and sub-steps are self-explanatory from the detailed drawings and description. One notes the Reason Code provides the schools options to customize their respective codes to meld and blend with the current system if needed. When using this portion of the system, personal information comes up to ensure right student was selected. Information such as name, parent, address, telephone number, schedule, etc.

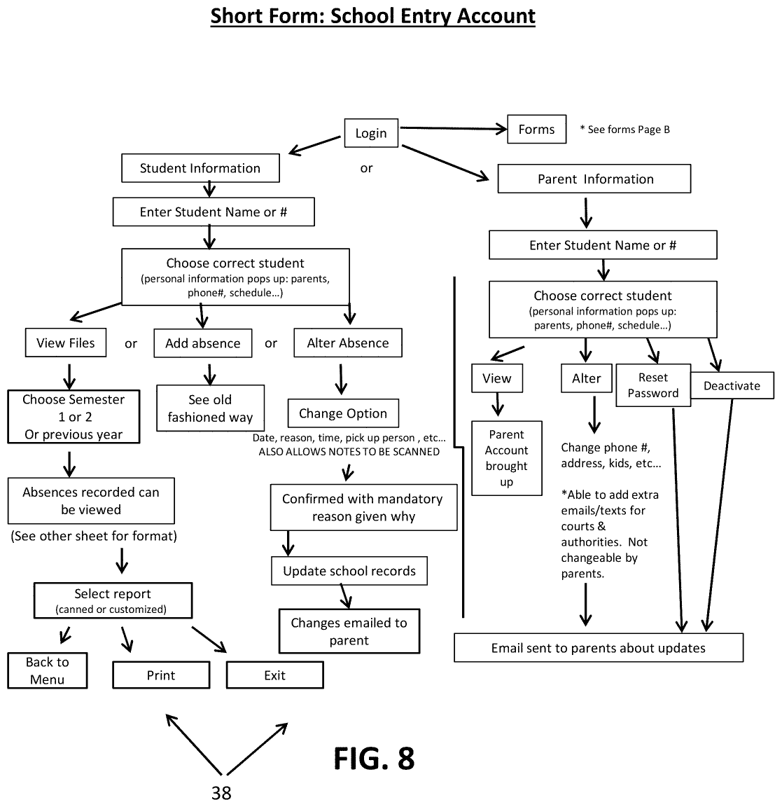

FIG. 8 is a Short Form: School Entry Account 38. The specific steps and sub-steps are self-explanatory from the detailed drawings and description.

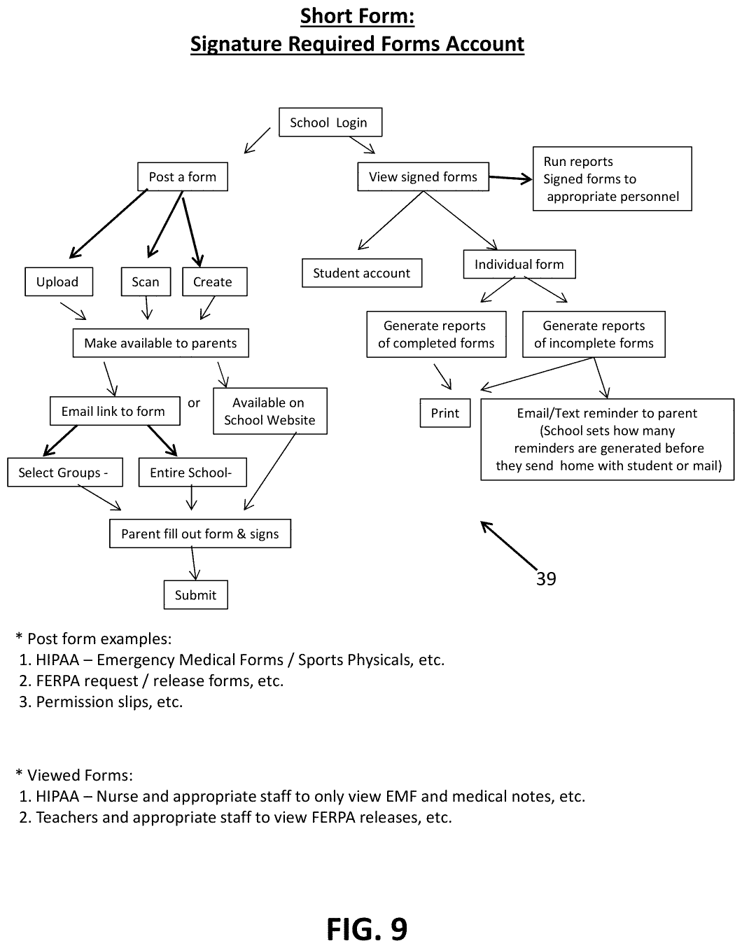

FIG. 9 is a Short Form Signature Required Forms Account 39. The specific steps and sub-steps are self-explanatory from the detailed drawings and description. Main features for any parent signature required form of both long and short forms include: school sets how many emails sent the old fashioned way of collecting paperwork kicks in/begins; a list is generated on non-compliers and 2^{nd} email sent—here the secretary/administrator needs to be printed a list; and a 3^{rd} email is sent if needed and the list reprinted. For privacy public posted or viewed for need:

```
1. Posted forms:
a) HIPPA - Emergency medical forms/Sports
  physicals, etc.
b) FERPA Request - Release forms, etc.
c) Permission Slips, etc.
2. Viewed forms:
a) HIPPA - Nurse and appropriate staff to only view
  EMFs and medical notes, etc.
b) Teachers and appropriate staff to view FERPA
  releases, etc.
```

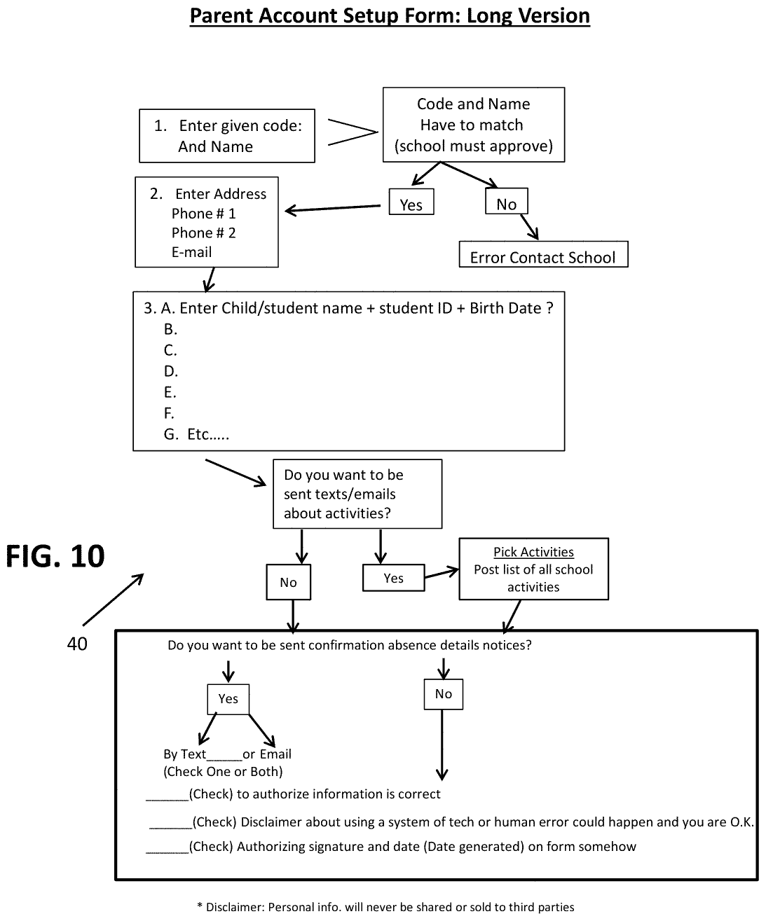

FIG. 10 is a Parent Account Setup Form: Long Form Version 40. The specific steps and sub-steps are self-explanatory from the detailed drawings and description.

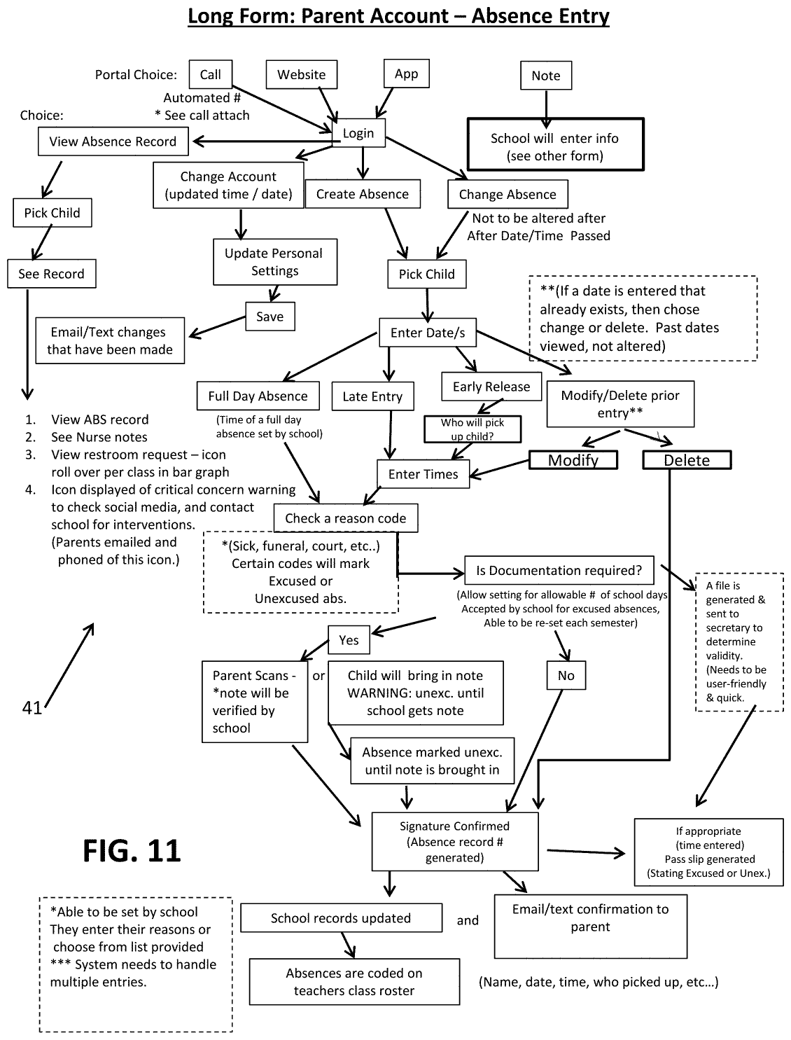

FIG. 11 is a Long Form: Parent Account—Absence Entry 41. The specific steps and sub-steps are self-explanatory from the detailed drawings and description. One notes several points: several entry/portal means for communicating and exchanging information choices—telephone call, electronic mail, website or smartphone applications; date and time not to be altered after Date/Time passed by parent (needs school authorization); if a date is entered that already exists, then one must choose—change or delete (past dates viewed, not altered). Other portions similar to short form which addresses and connects to the existing absence systems. In addition:

```
1) View absence record
2) See nurse notes
3) View rest room requests
4) Icon displayed of critical concern
  warning to check social media and contact
  school for interventions (parent emailed
  and phoned of this icon)
```

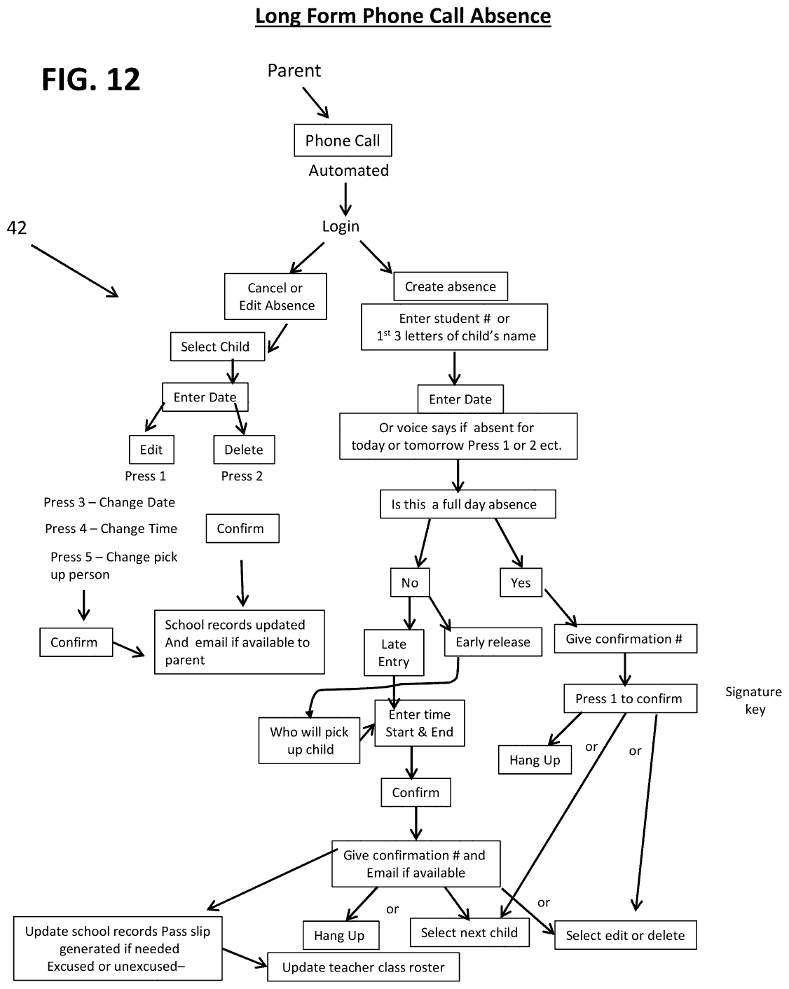

FIG. 12 is a Long Form Phone Call Absence flowchart 42. The specific steps and sub-steps are self-explanatory from the detailed drawings and description.

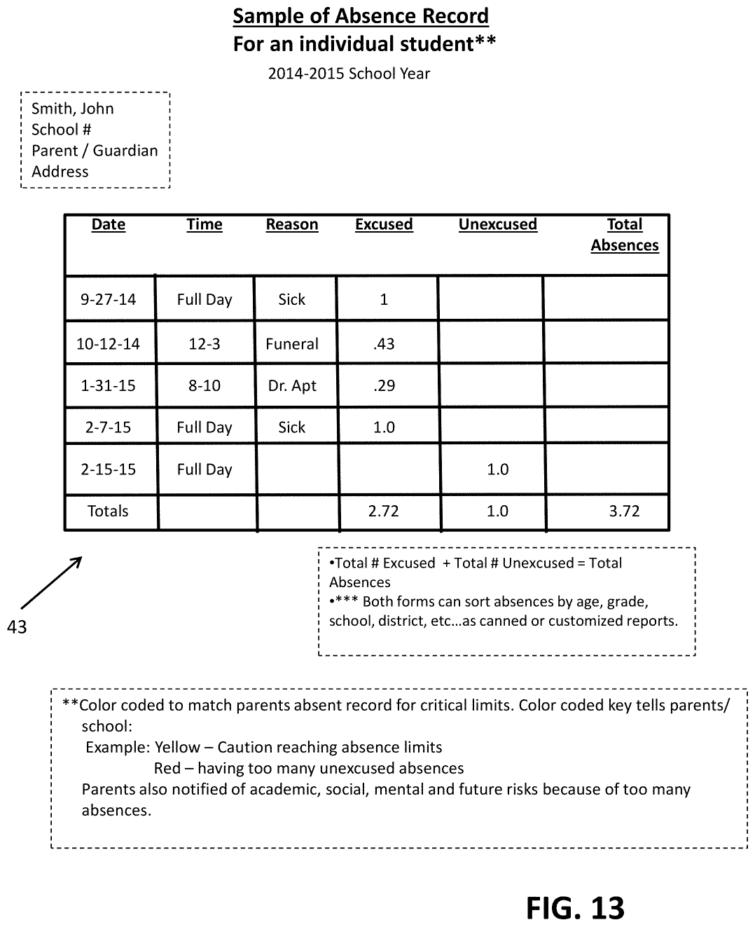

FIG. 13 is a Sample of Absence Record for a Long Form 43. The specific steps and sub-steps are self-explanatory from the detailed drawings and description. One notes: Long form absence record can include teachers, nurse & coaches as well as parents & school already added. Long Form as well as Short Form can create standard (canned) and customized reports by age, grade, school, district, etc. Color coded key tells parents/school: (example yellow-caution reaching absence limits, red-having too many unexcused absences). Parents also notified of academic, social, mental, and future risks because of too many absences.

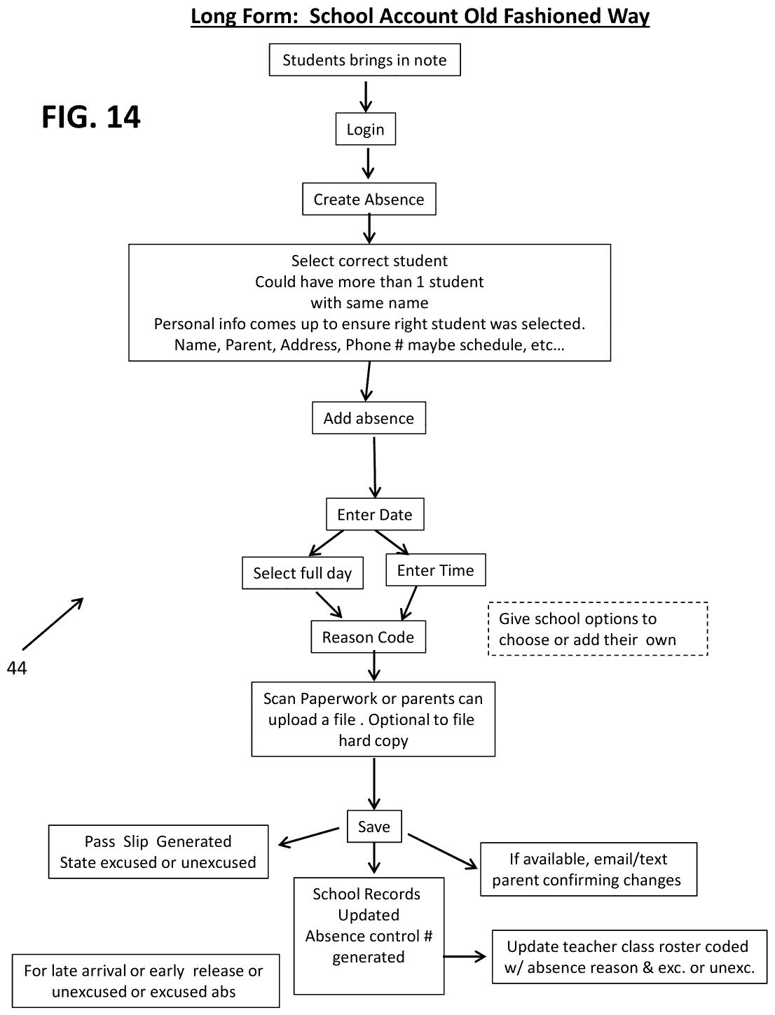

FIG. 14 is a Long Form: School Account done by the Old Fashioned Way 44. The specific steps and sub-steps are self-explanatory from the detailed drawings and description. Many give the school the option to customize sections for their own desire and use.

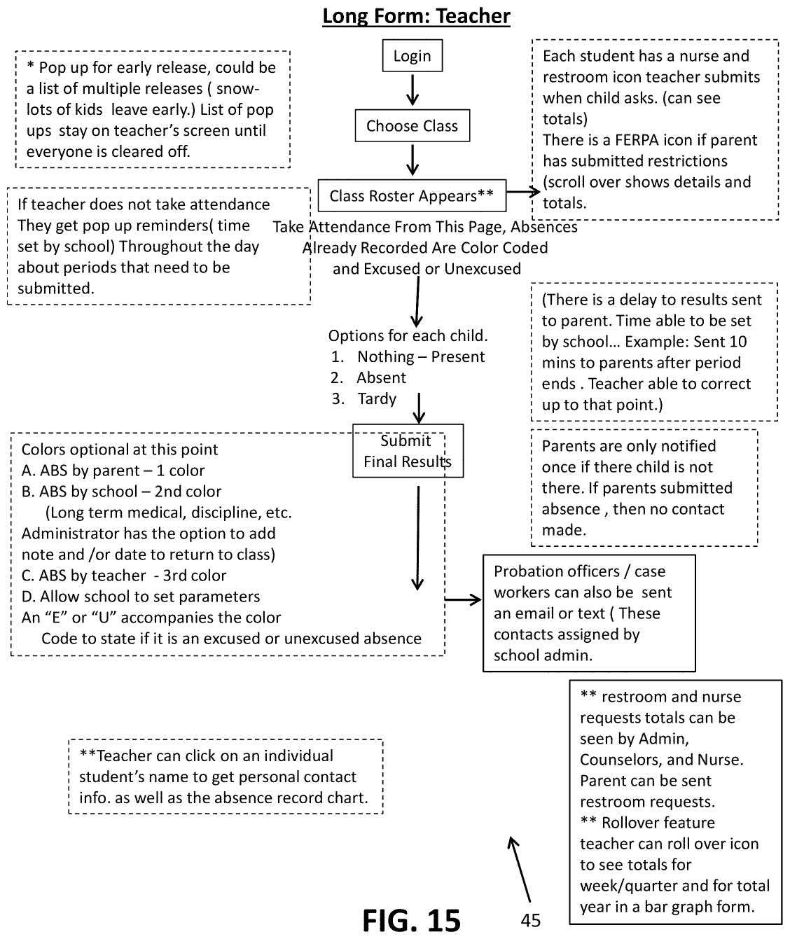

FIG. 15 is a Long Form: Teacher flowchart for a Long Form 45. The specific steps and sub-steps are self-explanatory from the detailed drawings and description. One notes in these drawings: Pop up for early release, could be a list of multiple releases (e.g. snow—lots of kids leave early); a list of pop ups stay on teacher's screen until everyone is cleared off; if teacher does not take attendance they get a pop up reminder (time to remind set by school) throughout the day about periods that need to be submitted; take attendance from this page; and absences are already recorded and color coded plus marked excused or un-excused [Colors optional at this point: A. ABS by parent—1 color; B. ABS by school—2^{nd} color; Long term medical, discipline, etc.; administrator has the option to add note and/or date to return to class); C. ABS by teacher—3^{rd} color; D. Allow school to set parameters] and an “E” or “U” accompanies the color to state if it is an excused (“E”) or unexcused (“U”) absence. Further features show there is a delay to results sent to parent at a time able to be set by school. For example: Send notice 10 minutes to parents after period ends. Teacher would be able to correct up to that point. Parents are only notified once if their child is not there. If parents submitted absence, then no contact is made. Further, probation officers/case workers can also be sent an email or text. (These contacts assigned by school administration). Here a teacher can click on an individual student's name to get personal contact information as well as the absence record chart. Other indicators that are shown include: (1) Each student has a nurse and rest room icon and each teacher submits when child asks (and can see totals); (2) There is a FERPA icon if the parent has submitted restrictions; (3) Rest room and nurse request “totals” can be seen by administration, counselors, and nurse; and a parent can be sent rest room requests; and (4) the appropriate staff can view totals for weeks/quarters/year.

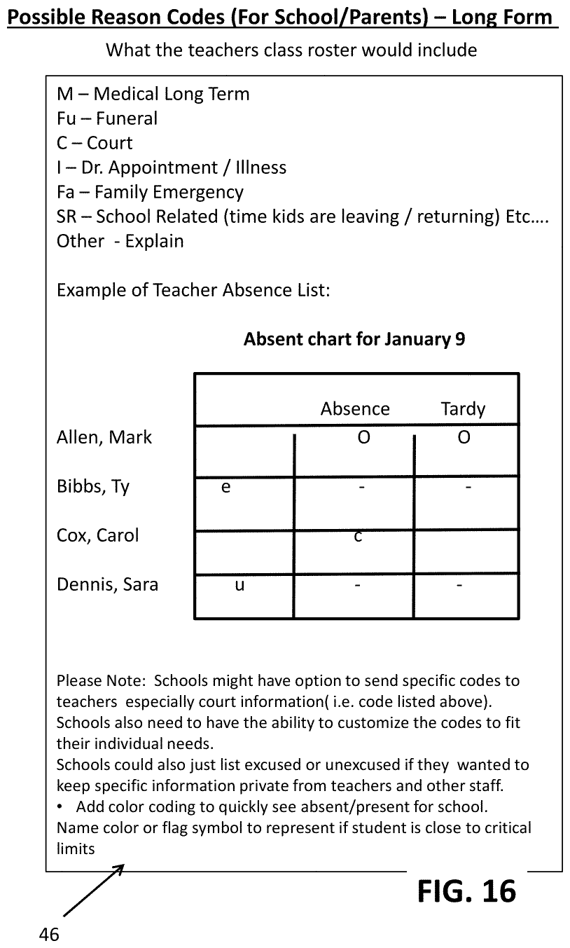

FIG. 16 is a Possible Reason Codes table (For School/Parents)—Long Form 46. The specific steps and sub-steps are self-explanatory from the detailed drawings and description. Reason codes, for example and not as a limitation are: M—Medical Long Term; Fu—Funeral; C—Court; I—Dr. Appointment/Illness; Fa—Family Emergency; SR—School Related (provides time kids are leaving/returning) and O—other reasons—space to explain. The schools have the ability to customize this to their individual needs with different opportunities to customize reports; number of excused/unexcused absences; time set by full day absence (Partial days) and whatever forms school wants signed. Other options or customization to consider with the Reason Codes are: (1) Add color coding to quickly see those absent/present for school event. (2) Give a catchy name or phrase to a reason, color a reason, or use a flag symbol to represent students getting close to or in critical limits of unexcused absences.

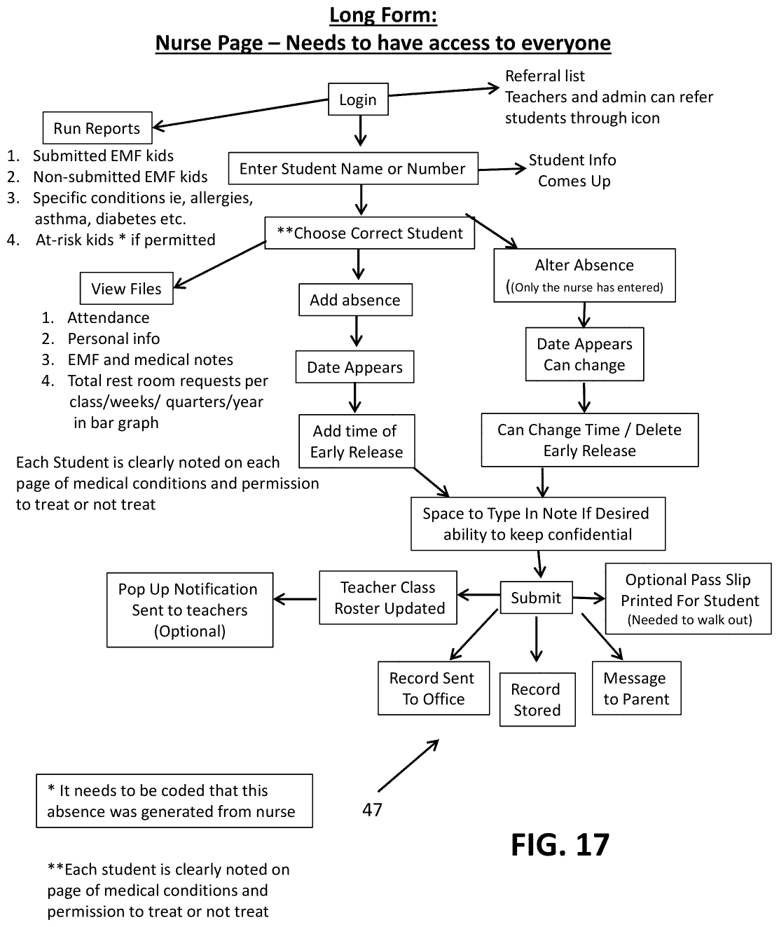

FIG. 17 is a flowchart for a Long Form: Nurse Page—this page needs to have access to everyone 47. The specific steps and sub-steps are mostly self-explanatory from the detailed drawings and description. In addition for the Long Form flow chart of the Nurses page:

```
1. Run reports:
  a. Submitted EMF students
  b. Non-submitted EMF students
  c. Specific conditions i.e. - allergies, asthma,
    diabetes, etc.
d. At risk, if permitted
2. Under “View Files”
  a. Attendance
  b. Personal information
  c. EMF's and medical notes
  d. Total rest room requests per class for
    weeks/quarters/year in graph form
3. Each student is clearly noted on page of medical
conditions and permission to treat or not treat
4. Referral list - Teachers and administration can
refer students through icon
5. Submitted note - Keep confidential for security
of data and privacy
```

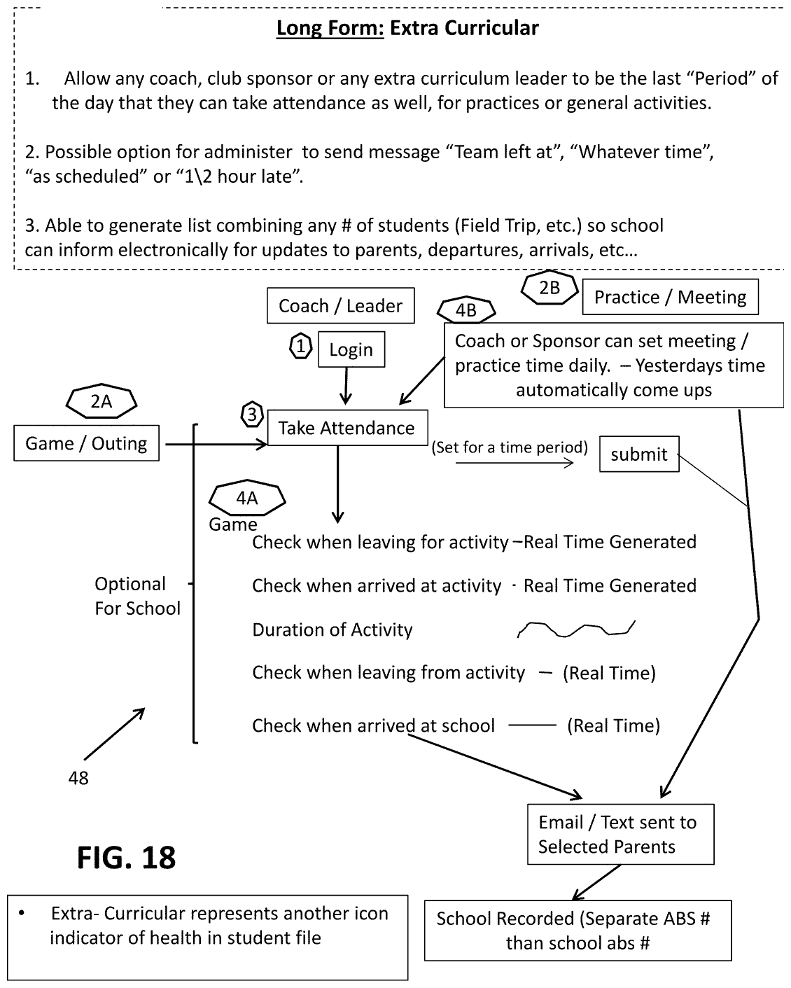

FIG. 18 is a flowchart for a Long Form: Extra Curricular activities 48. The specific steps and sub-steps are self-explanatory from the detailed drawings and description. (1) This allows any coach, club sponsor or any extra curriculum leader to be the last “Period” of the day that they can take attendance as well, for practices or general activities. (2) This provides a possible option for administer to send message “Team left at”, “Whatever time”, “as scheduled” or “1\2 hour late”. (3) This makes it able to generate list combining any # of students (Field Trip, etc.) so school can inform electronically for updates to parents, departures, arrivals, etc. This further permits: Check in real time when leaving for an activity; Check in real time when arrived for an activity; Check in real time the duration of the activity; Check in real time when leaving from an activity; and Check in real time when arriving back at the school. Extracurricular represents another icon indicator of health in the student file. This is a tremendous help to parents/guardians as well as increasing safety and security for the student.

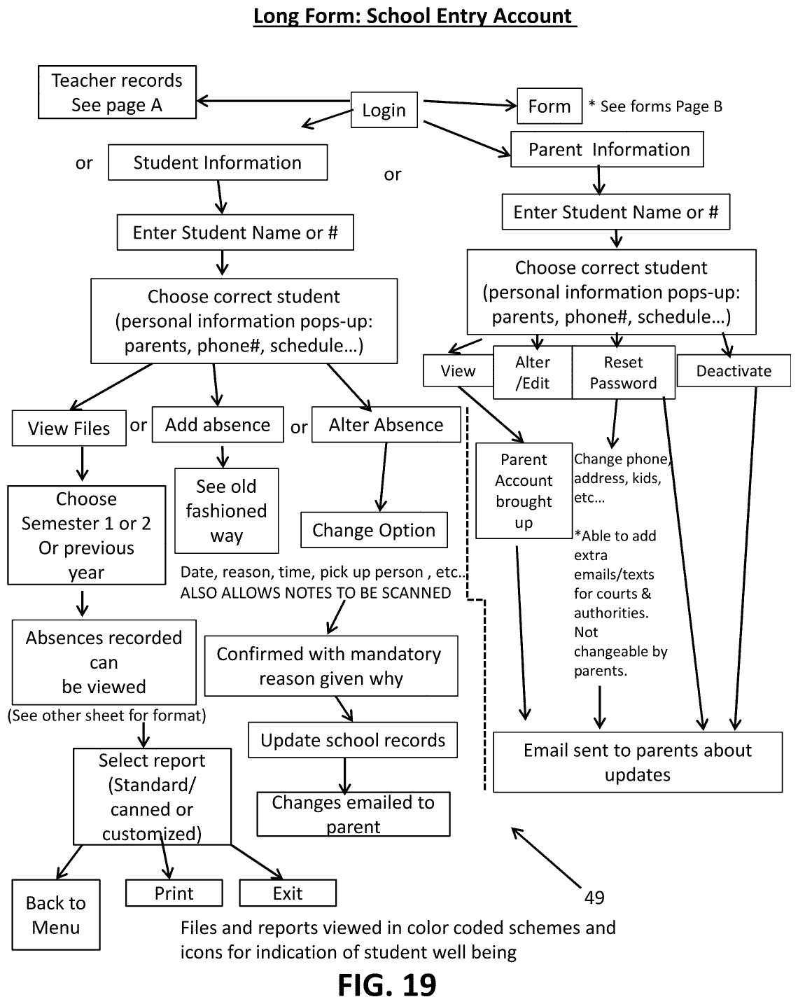

FIG. 19 is an Example of Long Form: School Entry Accounts 49. The specific steps and sub-steps are essentially self-explanatory from the detailed drawings and description. Files and reports viewed in color coded schemes and icons for indication of a student's well-being.

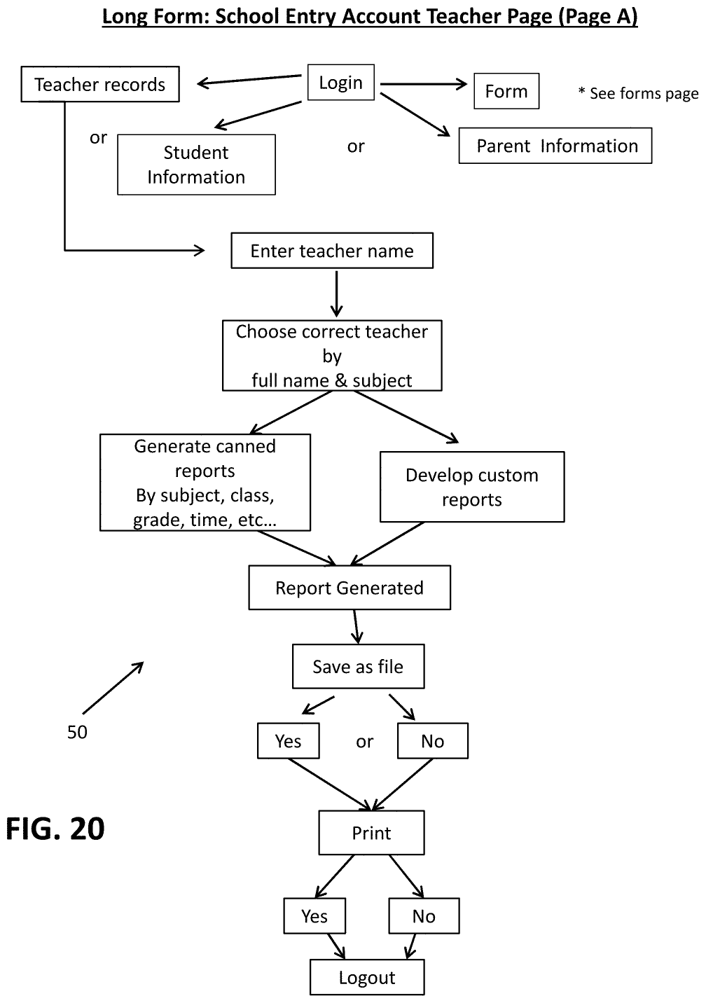

FIG. 20 is a Long Form: School Entry Account Teacher Page (Page A) 50. The specific steps and sub-steps are essentially self-explanatory from the detailed drawings and description.

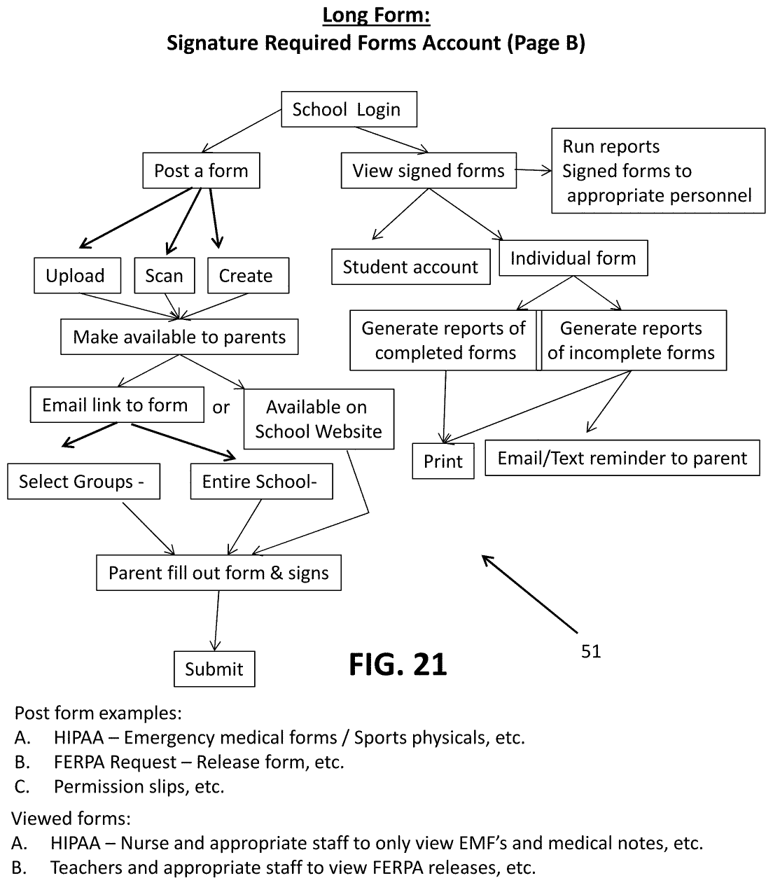

FIG. 21 is an Example of a Long Form: Signature Required Forms Account (Page B) 51. The specific steps and sub-steps are essentially self-explanatory from the detailed drawings and description. For privacy public posted or viewed for need:

```
1. Posted forms:
a) HIPPA - Emergency medical forms/Sports
  physicals, etc.
b) FERPA Request - Release form, etc.
c) Permission Slips, etc.
2. Viewed forms:
a) HIPPA - Nurse and appropriate staff to only view
  EMFs and medical notes, etc.
b) Teachers and appropriate staff to view FERPA
  releases, etc.
```

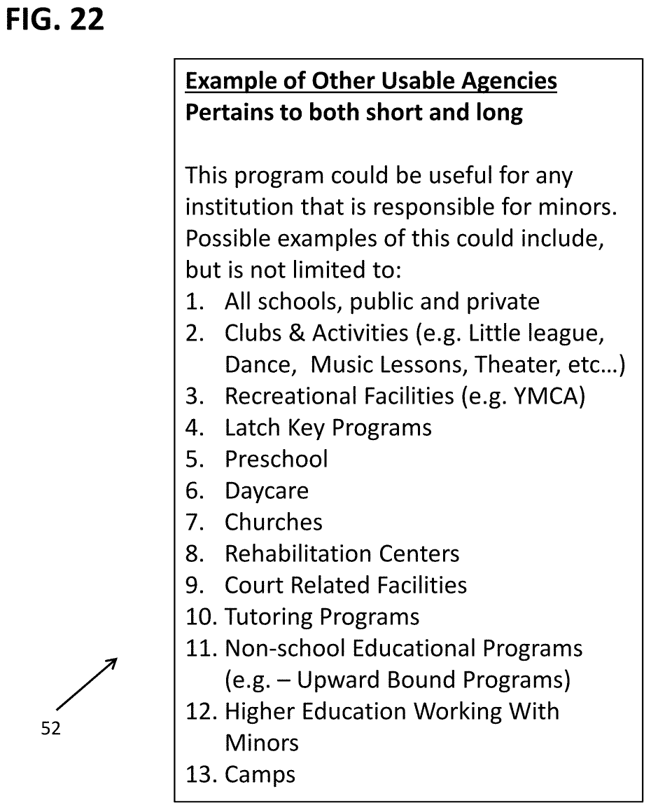

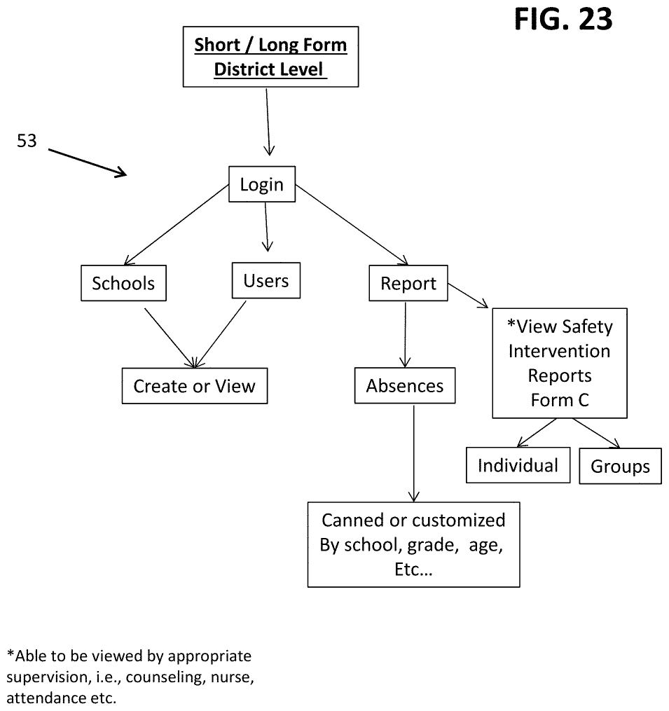

FIG. 22 is a list of Examples of Other Usable Agencies and FIG. 23 is a Short/Long Form District Level 53. The FIG. 22 is described and discussed below in the operations section. For FIG. 23 the specific steps and sub-steps are essentially self-explanatory from the detailed drawings and description. At the district level, reports are given to appropriate department supervisors (nursing, counseling, etc.). Here the district, at a macro level, can view safety intervention reports (Form C) on individuals and groups. Here the Interactive and Real-Time Absentee Reporting and Flagging System—short form 30 and Interactive and Real-Time Absentee Reporting and Flagging System—long form 30A provide easy access to attendance trends by school or school districts to superintendents. The results from the absentee systems 30, 30A are an unexpected and specific extension beyond absentee systems of the past. The use of the Interactive and Real-Time Absentee Reporting and Flagging System provides trend data to suggest further analysis of social media and other events. The combination of the Interactive and Real-Time Absentee Reporting and Flagging System and other analysis integrates the absentee system into a practical application unforeseen or expected by the absentee system on its own. The districts, by having the measurable/objective trends in the absentee data, can bolster requests for district, state, and/or federal funds in applying for grants to study the behavior changes indicated from the absenteeism trends. The results from studies funded by these grants will help district leadership set plans or develop counter measures to reverse negative trends. The further studies can also help districts even to understand the bases of or reasons for positive trends in order to support and even replicate the trends at other schools or districts.

FIG. 24 is a Long Form Counselor Entry Page 55. First one would Run a Report that shows the Attendance Data which is canned and customized in query groups (groups=age, grade, reason code, athletes, students that have little or no extra-curricular activities, students from specific neighborhood, students that gravitate toward black trench coat/goths, gangs, drugs, or other factors like students considered successful kids, etc.). With experience, the attendance reports on individuals would be canned and customized to show trends and set patterns. Alternatively, one could enter a student Name or control number and view a student's file. This would show a) Attendance percentages with reason codes, b) Nurse Requests, c) Restroom Requests, d) Grades, e) Discipline reports, and f) Extra-Curricular Absences. Any students with excessive absences and other indicators from the list could be Flagged as At-Risk. Any other known information on the student or child could be added by the flagger. (These could also be forwarded to administration personnel, nurses, other counselors, or to the parents or teachers or kept secured and private for counselor only. Information would indicate if a child should be Flagged for potential Interventions. See Form C, FIG. 24.

FIG. 25 is a Long Form Counselor Office Emotional Stability flow chart 57. The Counselor receives a flag from the Absentee system 30, 30A as a concerned input for a specific individual or a group. The attendance data would be collected on the flagged individual or group. For an individual, counselors would look for Patterns—Increases in Absences/Attendance at a set quantity. The individual Child's history, say greater than 10% or 18 days, or school parameters, number of consecutive days, etc. For a selected concern group, patterns and percentages would be checked. The same group members were uninvolved in extra-curricular activities, repeatedly missed every other Friday or four (4) times a month. For example and comparison cross-country girls (as a group) never miss but 16 year old girls from a certain neighborhood or in a certain “club” miss 18% every month, etc. These patterns indicate something is amiss—or may be amiss. With the data, charts or graphs could be made automatically: Color coded with icons. Very reader friendly to indicate how at risk kids are based on indicators like; attendance, grades, missing assignments, discipline, counselor and nurse visits, etc. Parents would be notified of risks and reminded to check social media, friend changes, behavior changes, school files, etc. Administration and nurses could be apprised. Patterns of concern or of positive influences may result. This could show:

```
Concerning Patterns
1. Interventions for
emotional safety and stability
  A. Social Media checks
  B. Grade check
  C. Missing assignments
  D. Nurse and restroom checks
  E. Group and individual
    counseling
  F. Parent contacted with
    recommendations
    1. Drug testing
    2. Psychological testing,
etc.
2. Collect info for grants
  A. Sent to admin, nurse,
    teachers, 3^{rd} parties.
  B. Kept confidential
Positive Patterns
1. Collect info for
  grants
2. Research and
  reinforce wanted
  behaviors
3. Notify parents/
  kids on great
  behavior
4. Use for peer
  mediation
  interventions
```

If an at-risk student is flagged by the school to have a social media check, then school administration with parent approval (or whatever law applies), can
1. Do general searches themselves,
2. Request that parents do searches, and/or
3. Have the social media companies scan the student's profile for unusual behavior and/or patterns (as per federal regulation) either at school/parent request. Also, evidence has showed that social media giants have the ability to influence people, they could be used as a form of positive influence. The companies could give at-risk clients/students positive posts to influence the person toward positive behaviors.

If suspicions are found: Then more psychological/drug testing can be suggested/required for the individual/group, as well as other interventions, including but not limited to therapies and physician referrals. And, secondly, social media companies can proactively scan regularly individuals and groups who are flagged by negative trends from the attendance systems 30, 30A. This might aid school officials, parents, and local law enforcement in a prioritized manner to better identify harmful behaviors. These behaviors are lingering but can be unearthed and indicated by absentee trends in absences. So it goes both ways: “The absentee system 30, 30A could be linked with a student's social media account and whichever one sees a concern (the absenteeism system 30, 30A or social media) and “a cross check could be done by the other and behavior would indicate if further interventions are needed”.

By providing trend data from the Real-Time Absentee System to a counselor, the counselor can consider and use the trend data to indicate a need for further analysis of social media. They can then contact the school administration and parents to seek additional information on social media sources like Facebook™, Twitter™ and cellphone texts, etc. This trend analysis can be further considered for possibly contacting authorities of a potential red flag student. This is an unexpected and specific extension beyond absentee systems of the past. The use of the Interactive and Real-Time Absentee Reporting and Flagging System provides trend data to suggest further analysis of social media and other events. The combination of the Interactive and Real-Time Absentee Reporting and Flagging System and other analysis integrates the absentee system into a practical application unforeseen or expected by the absentee system on its own.

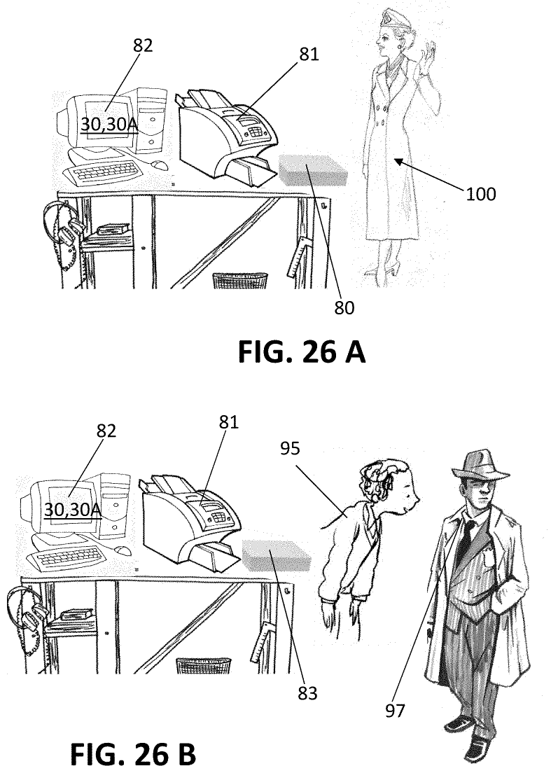

FIGS. 26A and 26B are sketches of nurse 100 and counselors 90 providing advanced medical release sheets 80 and (red) flag reports 83 from the Interactive and Real-Time Absentee Reporting and Flagging System for Schools, Parents and Other Institutions 30, 30A. Shown here includes the extended and unpredicted use of the systems 30, 30A that go far beyond a simple absentee system or the abstract ideas of some programs. Indicated in these sketches are: an Interactive and Real-Time Absentee Reporting and Flagging System—short form 30; an Interactive and Real-Time Absentee Reporting and Flagging System—long form 30A; an automatic/advance clearance sheets 80 by nurses 100 for absentee sheets or illness sheet that alert coaches and other sponsor plus permit them to seek medical (hospital) care for at risk students [diabetics, seizures, ADHD, blood thinners, heart ailment] but do not violate HIPAA and FERPA since parent/guardian approval was obtained through the absentee system 30, 30A; a printer 81; connected to terminal 82; a computer terminal 82 connected to absentee system 30, 30A; a counselor (red) flag report 83 based on other data in the absentee system 30, 30A; a teacher lounge 83; a counselor 95; a detective, FBI, and local authorities 97; and a nurse 100. This providing of the real-time medical permission from Parents available now in the Real-Time Absentee System can be accessed by the nurses. The nurses then extend the use of the data and use the permission with a printer for providing an advance clearance/permission sheets to coaches and after school event sponsors. This allows the coaches and sponsors to treat a student with certain medical conditions without delay and save time to get the student the needed medical attention immediately. The combination of the data from the Interactive and Real-Time Absentee Reporting and Flagging System and the providing coaches and sponsors the advanced clearance sheets is an unexpected and specific extension beyond absentee systems of the past. The use of the Interactive and Real-Time Absentee Reporting and Flagging System provides medical condition data to permit immediate help for the students if needed. The combination of the Interactive and Real-Time Absentee Reporting and Flagging System and printer by the nurse integrates the absentee system into a practical application unforeseen or expected by the absentee system on its own.

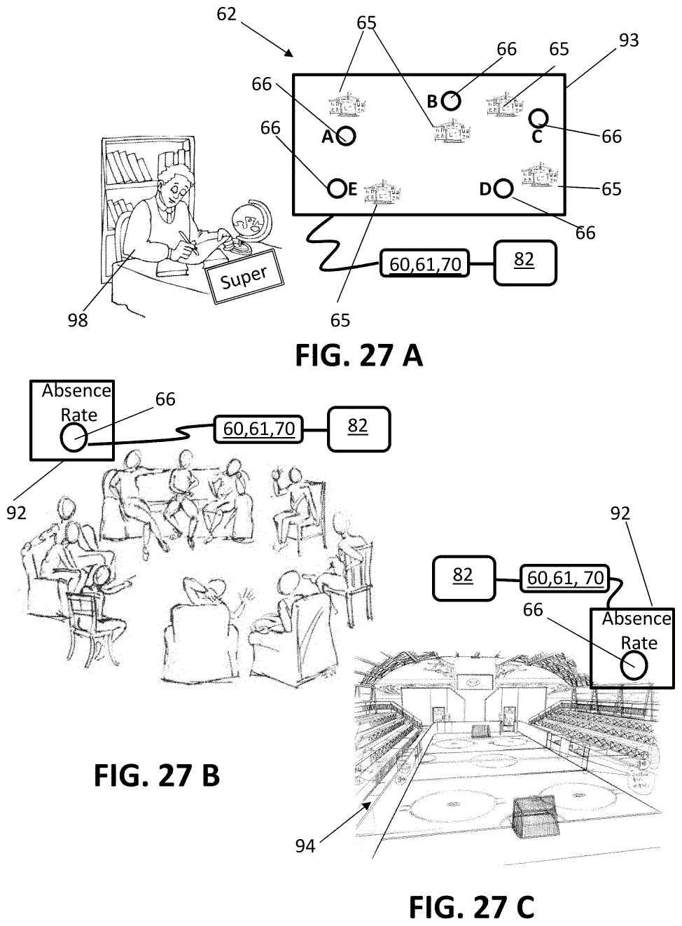

FIGS. 27A through 27C are sketches of the superintendent 98 with a school district board 62, a teacher lounge with an attendance board and a gymnasium with an attendance board all provided control from a computer and the Interactive and Real-Time Absentee Reporting and Flagging System for Schools, Parents and Other Institutions. Demonstrated by these three sketches are: a digital data to analog conversion device 60; a controller 61 to district school map 62 or other rating output device 90; a school map 62; a set of school locations 65; a green (under 6% absences)/yellow (6 to 8% absences)/red (over 10% absences) lights 66 (LED) for the grading period; a timer device 70 blinks light on/off for example, a 15 seconds period out of every 5 minutes for first 3 days after bulb has changed color code; a teacher lounge 83; an output device 90 such as large red/yellow/green light board, thermometer, audio system (that plays message or music pre-determined for absenteeism alerts to teachers in a lounge or students in a cafeteria or gymnasium 94; an absenteeism report board 92; a school report board 93; a gymnasium/auditorium 94 for students; and a superintendent 98.

The details mentioned here are exemplary and not limiting. Other specific components and manners specific to describing an Interactive and Real-Time Absentee Reporting and Flagging System for Schools, Parents and Other Institutions 30, 30A may be added as a person having ordinary skill in the art of absentee tracking and reporting and in the art of interactive communications readily understands and well appreciates.

### OPERATION OF THE PREFERRED EMBODIMENT

The Interactive and Real-Time Absentee Reporting and Flagging Reporting and Flagging System for Schools, Parents and Other Institutions 30, 30A has been described in the above embodiment. The manner of how the device operates is further described below. One notes well that the description above and the operation described here must be taken together to fully illustrate the concept of the Interactive and Real-Time Absentee Reporting and Flagging System for Schools, Parents and Other Institutions 30, 30A. The preferred embodiment of the Interactive and Real-Time Absentee Reporting and Flagging System for Schools, Parents and Other Institutions 30, 30A is comprised of: (a) an existing absentee reporting system or new reporting system; (b) a portal means for communicating and exchanging information such as a call-in website by email and/or cellphone application and/or telephone; (c) a log-in process to choose/and-or create a file for a specific child; (d) a review file of recent absentees and/or tardiness; (e) a manner to enter and/or edit a reason code for the absentee or tardiness; (f) a means for securely signing (electronic signature or pin codes or the like) for acknowledging absenteeism and other school forms; and (g) an interactive comments capability wherein the Interactive and Real-Time Absentee Reporting and Flagging System for Schools, Parents and Other Institutions may be accessed on a real time basis for interaction between school systems (teachers, secretary and administrators) with the parent, guardian and governmental institutions. An alternative embodiment is the system described above and further comprised of after school, curricular and extracurricular activities wherein sponsors or coaches can interact and advise parents/guardians, etc. of the location and presence of the student at such curricular and extracurricular activities. In addition, the Interactive and Real-Time Absentee Reporting and Flagging System—short form 30 and an Interactive and Real-Time Absentee Reporting and Flagging System—long form 30A provides the data to a digital data to analog conversion device 60 which signals a controller 61 to district school map 62 or other devices 90 such as large red/yellow/green light board, thermometer, audio system (that plays message or music pre-determined for absenteeism alerts to teachers in a lounge or students in a cafeteria or gymnasium 94, an absenteeism report board 92, a school report board 93 etc. that all use a timer device that blinks light on/off for example. Plus, the Absentee System 30, 30A provides initial data to a nurse and counselor that can print an automatic/advance clearance sheets 80 for absentee sheets or illness sheet that alert coaches and other sponsor plus permit them to seek medical (hospital) care for at risk students [diabetics, seizures, ADHD, blood thinners, heart ailment] but do not violate HIPAA and FERPA since parent/guardian approval was obtained through the absentee system 30, 30A. It also permits printing a counselor flag report 83 based on other data in the absentee system 30, 30A.

Several potential using agencies as current and future users are anticipated and indicated in FIG. 22 for the Interactive and Real-Time Absentee Reporting and Flagging System for Schools, Parents and Other Institutions 30, 30A. These examples, and not limitations, are as follows. This program could be useful for any private/government institution that is responsible for minors. Possible examples of this could include, but is not limited to:

| No. | Description |
|---|---|
| 1 | All schools, public and private |
| 2 | Clubs & Activities (e.g. Little |
| | league, Dance, Music Lessons, |
| | Theater, etc.) |
| 3 | Recreational Facilities (e.g. YMCA) |
| 4 | Latch Key Programs |
| 5 | Preschool |
| 6 | Daycare |
| 7 | Churches |
| 8 | Rehabilitation Centers |
| 9 | Court Related Facilities |
| 10 | Tutoring Programs |
| 11 | Non-school Educational Programs (e.g. - |
| | Upward Bound Programs) |
| 12 | Higher Education Working With Minors |
| 13 | Camps |

Many current and future enhancements and uses are anticipated for the Interactive and Real-Time Absentee Reporting and Flagging System for Schools, Parents and Other Institutions 30, 30A. Some examples, and not limitations, are:

| | |
|---|---|
| A | Technology Advancements: |

Always progressing with cutting edge advancements in human
recognition technology, including, but not limited to
fingerprint identification, voice recognition, face
identification/recognition, microchip implants (micro-
chipping), and eye identification.

| B | Administration-Staff-Employees: | |
|---|---|---|
| | 1. | An announcement system updating all affected employees of |
| | | important changes including office and building |
| | | information, as well as district, state, and federal |
| | | mandates. |
| | 2. | Able to report and record all teacher/employee |
| | | evaluations for individual district/company requirements |
| | | as well as state requirements: Gradebook; discipline; |
| | | evaluation; foreign language activities; scholarships; |
| | | interactive communication with government agencies |
| | | (therapy, courts, probation, Child services, etc.); |
| | | parents and guardians; and emergency alerts. |
| | 3. | Create “locker space” for employees and students to store |
| | | online data. |
| | 4. | Able to assign students virtual assignments for snow |
| | | days, college readiness, or absences, etc. |
| | 5. | Teachers can offer forms to be signed on their school web |
| | | pages. |
| C | Students: | |
| | 1. | Discipline reports and records are able to be |
| | | electronically generated and submitted from teachers to |
| | | administration, with school option to also notify |
| | | parents. |
| | 2. | Automatic notification to administration when students |
| | | are marked “tardy” a certain number of times. Schools |
| | | can adjust this feature to be a school-wide policy or can |
| | | accumulate for individual classes. |
| | 3. | Offer the program in foreign languages. |
| | 4. | Able to create and manage individual student schedules, |
| | | teacher schedules, and the master schedule. |
| | 5. | Students can electronically sign for given |
| | | responsibilities (i.e. - library books, classroom |
| | | documents, athletic events, etc.) |
| | 6. | Students can have access to or check out online |
| | | textbooks. |
| D. | Parents: | |
| | 1. | Parents can be contacted for emergency messaging, |
| | | individually, school, or district wide. |
| | 2. | Schools can be given the option to allow |
| | | parents/guardians to electronically sign for viewing and |
| | | being informed of grade interims and report cards. |
| | 3. | Parents are able to electronically receive official |
| | | signed documents from the school (transcripts, diplomas, |
| | | grade reports, proof of attendance, possibly with an |
| | | “electronic watermark”, etc.) and electronically sign |
| | | official documents. |
| | 4. | Parents can enroll and/or withdraw students by |
| | | electronically signing required forms. |
| E. | Community: | |
| | 1. | For scholarship/award purposes, this program is able to |
| | | generate reports to colleges, employers, or any community |
| | | agency about community service, attendance of extra- |
| | | curricular activities, field trips, or any other school |
| | | related information. |
| | 2. | Communicate openly between school and courts, probation |
| | | officers, social services, therapists, or any business |
| | | dealing with the students regarding attendance, grades, |
| | | behavior or any other expected school attitude. |
| | 3. | Able to send any generated report to government agencies, |
| | | consultants, presenters, etc., about school related |
| | | topics and statistics for the betterment of the system. |

With this description it is to be understood that the Interactive and Real-Time Absentee Reporting and Flagging System for Schools, Parents and Other Institutions 30, 30A is not to be limited to only the disclosed embodiment of system/process. The features of the Interactive and Real-Time Absentee Reporting and Flagging System for Schools, Parents and Other Institutions 30, 30A are intended to cover various modifications and equivalent arrangements included within the spirit and scope of the description.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described. All patents and publications mentioned herein, including those cited in the Background of the application, are hereby incorporated by reference to disclose and described the methods and/or materials in connection with which the publications are cited.

Any of the publications discussed herein are provided solely for their disclosure prior to the filing date of the present application. Nothing herein is to be construed as an admission that the present inventions are not entitled to antedate such publication by virtue of prior invention. Further, the dates of publication provided may be different from the actual publication dates which may need to be independently confirmed.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

As used herein, spatial or directional terms, such as “left,” “right,” “front,” “back,” and the like, relate to the subject matter as it is shown in the drawing FIGS. However, it is to be understood that the subject matter described herein may assume various alternative orientations and, accordingly, such terms are not to be considered as limiting. Furthermore, as used herein (i.e., in the claims and the specification), articles such as “the,” “a,” and “an” can connote the singular or plural. Also, as used herein, the word “or” when used without a preceding “either” (or other similar language indicating that “or” is unequivocally meant to be exclusive—e.g., only one of x or y, etc.) shall be interpreted to be inclusive (e.g., “x or y” means one or both x or y). Likewise, as used herein, the term “and/or” shall also be interpreted to be inclusive (e.g., “x and/or y” means one or both x or y). In situations where “and/or” or “or” are used as a conjunction for a group of three or more items, the group should be interpreted to include one item alone, all of the items together, or any combination or number of the items. Moreover, terms used in the specification and claims such as have, having, include, and including should be construed to be synonymous with the terms comprise and comprising.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

What is claimed is:

1. An Interactive and Real-Time Absentee Reporting and Flagging System
including a group of computers controlled by a school and an approved parent and/or an approved guardian, a school controlled website, and a series of smartphones for school time and extracurricular events for the school, the approved parents and a set of other Institutions comprised of:
(a) an existing absentee reporting system;
(b) a portal means between the group of computers, the school controlled website, and the series of smartphones for communicating real time and interactively exchanging information among the approved parent and/or approved guardian, a group of teachers, and a group of school administrators;
(c) a log-in process to choose/and-or create a file for a specific child and to initially approve the approved parent and/or the approved guardian for use of the portal means;
(d) a review file of a set of recent absentees and tardiness events for the specific child with a reason code;
(e) a manner to enter and/or edit the reason code by the teacher or the school administrator for the set of recent absentee or tardiness of the specific child;
(f) a means for securely signing by the approved parent and/or the approved guardian for acknowledging absenteeism and other school forms of the specific child;
(g) an interactive comments capability between the approved parent and/or the approved guardian, the group of teachers, and the group of school administrators; and
(h) augmenting the Real-Time Absentee System with monitoring after school and extracurricular activities wherein sponsors and coaches can interact and immediately advise and message the approved parents and/or the approved guardians, and the school teachers and the school administrators of the immediate and real-time location, whereabouts, and presence, as to arrival and duration, of the specific student at such extra-curricular activities
wherein the Interactive and Real-Time Absentee Reporting and Flagging System for a school time and an extracurricular event for the Schools, the approved Parents and/or the approved guardians and a set of Other Institutions by the use of the group of computers controlled by the approved parent and/or the approved guardian and the school, the school controlled website, and the series of smartphones is accessed on a real time basis for interaction between school system including the teachers, a secretary, and the school administrators with the approved parent and/or the approved guardian and a group of private/government institution and
wherein the Real-Time Absentee System controls and provides data to unexpected output systems for use by the school districts.

2. The system described in claim 1 wherein the unexpected output systems I selected from a group consisting of absentee rates provided to the superintendent at each school location for a district school map 62; an absentee alert to a group of teachers in a lounge, an absentee alert to a group of students in a cafeteria or gymnasium, absentee data to a nurse for an advance clearance sheets 80 that alert coaches and other sponsor plus permit them to seek medical (hospital) care for at risk students [diabetics, seizures, ADHD, blood thinners, heart ailment] but do not violate HIPAA and FERPA, and absentee data to a counselor to permit printing a flag report 83 to local authorities.

3. The system described in claim 1 wherein the portal means for communicating is the school controlled website.

4. The system described in claim 1 wherein the portal means for communicating is using a telephone to contact a school teacher or school administrator.

5. The system described in claim 1 wherein the portal means for communicating is using a smartphone application from the approved parent and/or approved guardian to contact the school by a controlled website.

6. The system described in claim 1 wherein the portal means for communicating is using an electronic mail system by the approved parent and/or approved guardian to contact the school teacher and/or school administrator.

7. The system described in claim 1 wherein the reason code is selected from the group consisting of: M—Medical Long Term; Fu—Funeral; C—Court; I—Dr. Appointment/Illness; Fa—Family Emergency; SR—School Related and O—other reasons.

8. The system described in claim 1 wherein the means for securely signing is an electronic signature by an approved parent and/or approved guardian.

9. The system described in claim 1 wherein the set of Other Institutions is selected from the group consisting of all schools, public and private; Clubs & Activities including: Little league, Dance, Music Lessons, Theater; Recreational Facilities; Latch Key Programs; Preschool; Daycare; Churches; Rehabilitation Centers; Court Related Facilities; Tutoring Programs; Non-school Educational Programs including Upward Bound Programs; Higher Education Working With Minors; and Camps.

10. The system described in claim 1 wherein the interactive comments capability is selected from the group consisting of email comments; text comments through a smartphone application; an email a sound recording; email a video response; attach recorded comments through a smartphone application; and attach videoed comments through a smartphone application.

11. An Interactive and Real-Time Absentee Reporting and Flagging System including a group of computers controlled by a school and an approved parent and/or an approved guardian, a school controlled website, and a series of smartphones for school time and extracurricular events for the school, the approved parents and a set of other Institutions comprised of:
(a) a newly developed absentee reporting system;
(b) a portal means between the group of computers, the school controlled website, and the series of smartphones for communicating real time and interactively exchanging information among the approved parent and/or approved guardian, a group of teachers, and a group of school administrators;
(c) a log-in process to choose/and-or create a file for a specific child and to initially approve the approved parent and/or the approved guardian for use of the portal means;
(d) a review file of a set of recent absentees and tardiness events for the specific child with a reason code;
(e) a manner to enter and/or edit the reason code by the teacher or the school administrator for the set of recent absentee or tardiness of the specific child;
(f) a means for securely signing by the approved parent and/or the approved guardian for acknowledging absenteeism and other school forms of the specific child;
(g) an interactive comments capability between the approved parent and/or the approved guardian, the group of teachers, and the group of school administrators;
(h) augmenting the Real-Time Absentee System with monitoring after a school and extracurricular activities wherein sponsors and coaches can interact and immediately advise and message the approved parents and/or the approved guardians, and the school teachers and the school administrators of the immediate and real-time location whereabouts, and presence, as to arrival and duration, of the specific student at such extracurricular activities;
(i) providing real-time medical permission from Parents to the Real-Time Absentee System which can be accessed by the nurses for using the permission and a printer for providing an advance clearance/permission sheets to treat a student with medical conditions; and
(j) providing trend data from the Real-Time Absentee System to a counsellor for consideration and use of the trend data to indicate a need for further analysis of social media and for consideration contacting authorities of a potential red flag student
wherein the Interactive and Real-Time Absentee Reporting and Flagging System is accessed on a real time basis for interaction between school system including the teachers, a secretary, and the school administrators with the approved parent and/or the approved guardian and a group of private/government institution.

12. The system described in claim 11 wherein the unexpected output systems is selected from a group consisting of absentee rates at each school location for a district school map 62 is provided to the superintendent; an absentee alert is provided to a group of teachers in a lounge; an absentee alert is provided to a group of students in a cafeteria or gymnasium; a set of absentee data is provided to a nurse for an advance clearance sheets 80 that alert coaches and other sponsor plus permit them to seek medical (hospital) care for at risk students [diabetics, seizures, ADHD, blood thinners, heart ailment] but do not violate HIPAA and FERPA; and, a set of absentee data is provided to a counselor to permit printing a flag report 83 to local authorities.

13. The system described in claim 11 wherein the portal means for communicating is the school controlled website.

14. The system described in claim 11 wherein the portal means for communicating is using a telephone to contact a school teacher or school administrator.

15. The system described in claim 11 wherein the portal means for communicating is using a smartphone application from the approved parent and/or approved guardian to contact the school by a controlled website.

16. The system described in claim 11 wherein the portal means for communicating is using an electronic mail system by the approved parent and/or approved guardian to contact the school teacher and/or school administrator.

17. The system described in claim 11 wherein the reason code is selected from the group consisting of: M—Medical Long Term; Fu—Funeral; C—Court; I—Dr. Appointment/Illness; Fa—Family Emergency; SR—School Related and O—other reasons.

18. The system described in claim 11 wherein the means for securely signing is an electronic signature by an approved parent and/or approved guardian.

19. The system described in claim 11 wherein the set of Other Institutions is selected from the group consisting of all schools, public and private; Clubs & Activities including Little league, Dance, Music Lessons, Theater; Recreational Facilities including :YMCA; Latch Key Programs; Preschool; Daycare; Churches; Rehabilitation Centers; Court Related Facilities; Tutoring Programs; Non-school Educational Programs including Upward Bound Programs; Higher Education Working With Minors; and Camps.

20. The system described in claim 11 wherein the interactive comments capability is selected from the group consisting of email comments; text comments through a smartphone application; an email a sound recording; email a video response; attach recorded comments through a smartphone application; and attach videoed comments through a smartphone application.
